(19) United States
(12) Patent Application Publication
(10) Pub. No.: US 2008/0126993 A1
(43) Pub. Date: May 29, 2008

(54) REPRODUCTION APPARATUS, DISPLAY CONTROL METHOD AND DISPLAY CONTROL PROGRAM

(75) Inventors: So Fujii, Tokyo (JP); Takafumi Azuma, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/865,357

(22) Filed: Oct. 1, 2007

(30) Foreign Application Priority Data
Oct. 2, 2006 (JP) 2006-271252

(51) Int. Cl. G06F 3/048

(52) U.S. Cl. 715/840

(57) ABSTRACT

A reproduction apparatus for reproducing content data, includes: an inputting section to which content data, a plurality of button images, and button control information including display control information and a command to be executed are inputted. The apparatus further includes: an operation inputting section configured to accept a user operation; and a control section configured to perform display control of some state of the button by the button images based on the display control information and perform execution control of the command in response to the user operation for the operation inputting section.

### CROSS REFERENCES TO RELATED APPLICATIONS

The present invention contains subject matter related to Japanese Patent Application JP 2006-271252, filed in the Japan Patent Office on Oct. 2, 2006, the entire contents of which being incorporated herein by reference.

### BACKGROUND OF THE INVENTION

1. Field of the Invention

This invention relates to a reproduction apparatus, a display control method and a display control program which allow an interactive operation by a user for a content recorded on a recording medium having a large capacity such as a blue-ray disc (Blu-ray Disc).

2. Description of the Related Art

In recent years, as standards for disk-type recording media which can be recorded and can be removed from a recording and/or reproduction apparatus, the Blu-ray Disc (registered trademark) standards have been placed into practical use. According to the Blu-ray Disc standards, a disk having a diameter of 12 cm and a cover layer of 0.1 mm is used as a recording medium and a blue-violet laser of a wavelength of 405 nm is used as an optical system while an objective lens of a numerical aperture of 0.85 is used to implement a recording capacity of 27 GB (gigabytes) in the maximum. Consequently, a BS (Broadcasting Satellite) digital high-definition broadcast in Japan can be recorded for more than two hours without any deterioration of the picture quality.

As a source (supply source) of an AV (Audio/Video) signal to be recorded on this recordable optical disk, traditionally available sources based on an analog signal, for example, from an analog television broadcast and those based on a digital signal from a digital television broadcast such as, for example, a BS digital broadcast are supposed to be available. In the Blu-ray Disc standards, standards which prescribe a method of recording an AV signal from such broadcasts as mentioned above have been prepared already.

Meanwhile, as derivative standards of the Blu-ray Disc at present, activities for developing a recording medium for reproduction only on which a movie, music or the like is recorded in advance are proceeding. Although a DVD (Digital Versatile Disc) has already been spread widely as a disk-type recording medium for recording a movie or music, the optical disk for reproduction only based on the Blu-ray Disc standards is much different from and superior to existing DVDs in that it can record high-definition television images for more than two hours while keeping high picture quality by making most of a large capacity and a very high transfer rate of the Blu-ray Disc.

Incidentally, when a content of a movie or the like is recorded on a disk and the disk is sold or distributed as a package medium, a user interface for controlling execution of various programs relating to the content is frequently recorded on the disk together with the content. A representative one of such user interfaces is menu display. As an example of the menu display, a button for selecting a function is prepared as a button image such that the function allocated to the button is executed if the button is selected and determined using a predetermined inputting mechanism.

For the button, usually three states are defined including a selected state wherein the button is selected, an activated state wherein the function is activated in response to an instruction to the selected button to activate the function and a normal state wherein the button is not in any of the selected state and the activated state. For example, if a button displayed on a screen is placed into the selected state using a cross key of a remote control commander compatible with a player or the like and then a determination key is depressed, then the button is placed into the activated state and the function allocated to the button is activated.

Incidentally, the blue-ray disc allows use of a programming language or a script language having a higher function than that used in existing DVDs in addition to the feature that it has a great recording capacity as described above. Further, also a content itself recorded on the blue-ray disc has a higher picture quality than that of a content recorded on a conventional DVD. Therefore, also in such menu display as described above, it is tried, for example, to use animation display of a button image or associate sound data with a button image to improve the operability to the user and further raise the added value.

A technique which uses an animation for a menu button for operating a menu relating to an optical recording medium is disclosed in JP-2006-521607T.

Animation display of a button image is implemented, for example, by associating a plurality of button images with one button and successively and switchably displaying the button images at predetermined time intervals. This button display is continued, for example, until all of a series of animations are displayed. This similarly applies also where sound data are associated with the button image. In this instance, the button display is continued, for example, until the sound data are reproduced to the last end.

### SUMMARY OF THE INVENTION

Here, a button formed from one object, that is, from only one button image, is considered. It is considered that, even if a button is formed from only one object, where a program describes that the button should be displayed, the producer side of the content intends to show the button to the user.

Conventionally, a button formed from one object has a problem that, after it is displayed on a screen for a period of time corresponding to one frame, that is, for a period of time of one vertical synchronizing signal, it is sometimes erased from the screen immediately. It is considered that such display is given, for example, where the processing capacity of the player is so high that it can process display of a button image at a high speed or for the convenience in installation of the player. In this instance, there is a problem in that the intention of the producer side is not conveyed to the user. Also to the user side, it is a problem that it is not known whether or not an operation for the button is accepted.

On the other hand, where a menu display image is configured hierarchically from a plurality of pages, it is considered preferable that, if an operation for a button for changing over between the pages or a button to which such a function that, if the button is placed into the selected state, a command is executed automatically is allocated is performed, then execution of the command and erasure of the button is performed immediately. In this manner, a display control method is desired by which a button formed only from one object can be displayed appropriately in response to such different conditions as described above.

Therefore, it is desirable to provide a reproduction apparatus, a display control method and a display control program by which a button for allowing an interactive operation by a user for a content to be reproduced can be displayed appropriately.

According to an embodiment of the present invention, there is provided a reproduction apparatus for reproducing content data, including an inputting section to which content data, a plurality of button images individually associated with three states including a normal state, a selected state and an activated state for displaying a button by which the three stages can be defined and which is used in an operation screen image for urging a user to perform operation, and button control information including display control information for controlling display of the plural button images and a command to be executed in response to the activated state are inputted. The apparatus further includes an operation inputting section configured to accept a user operation, and a control section configured to perform display control of the normal state, selected state and activated state of the button by the button images based on the display control information and perform execution control of the command in response to the user operation for the operation inputting section. The control section is operable to decide, when only one of the button images is associated with the activated state of the button, based on the display control information whether or not the display of the one button image should be performed for a predetermined period of time within which the activated state of the button can be presented explicitly and then execute the command after the display of the button image associated with the activated state of the button comes to an end.

According to another embodiment of the present invention, there is provided a display controlling method including the steps of performing, in response to a user operation for an operation inputting section which accepts a user operation, based on display control information for controlling display of a plurality of button images associated with three states including a normal state, a selected state and an activated state for displaying a button by which the three stages can be defined and which is used in an operation screen image for urging a user to perform operation, display control of the normal state, selected state and activated state of the button by the button images. The method further including the step of deciding, when only one of the button images is associated with the activated state of the button, based on the display control information, whether or not the display of the one button image should be performed for a predetermined period of time within which the activated state of the button can be presented explicitly, and executing a command, which is executed in response to the activated state of the button, after the display of the button image associated with the activated state of the button comes to an end.

According to a further embodiment of the present invention, there is provided a display control program for causing a computer apparatus to execute a display control method, the display control method including the steps of performing, in response to a user operation for an operation inputting section which accepts a user operation, based on display control information for controlling display of a plurality of button images associated with three states including a normal state, a selected state and an activated state for displaying a button by which the three stages can be defined and which is used in an operation screen image for urging a user to perform operation, display control of the normal state, selected state and activated state of the button by the button images. The method further includes the step of deciding, when only one of the button images is associated with the activated state of the button, based on the display control information, whether or not the display of the one button image should be performed for a predetermined period of time within which the activated state of the button can be presented explicitly, and executing a command, which is executed in response to the activated state of the button, after the display of the button image associated with the activated state of the button comes to an end.

In the reproduction apparatus, display control method and display control program, display control is performed in response to a user operation for an operation inputting section which accepts a user operation, based on display control information for controlling display of a plurality of button images associated with three states including a normal state, a selected state and an activated state for displaying a button by which the three stages can be defined and which is used in an operation screen image for urging a user to perform operation. In this instance, display control of the normal state, selected state and activated state of the button by the button images is performed. Then, it is decided, when only one of the button images is associated with the activated state of the button, based on the display control information, whether or not the display of the one button image should be performed for a predetermined period of time within which the activated state of the button can be presented explicitly. Then, a command, which is executed in response to the activated state of the button, is executed after the display of the button image associated with the activated state of the button comes to an end. Therefore, there is an advantage that, even where only one button image is associated with the activated state of the button, the button image can be displayed appropriately.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a diagrammatic view generally showing a data model of a BD-ROM;

FIG. 2 is a diagrammatic view illustrating an index table;

FIG. 3 is a view of the Unified Modeling Language illustrating a relationship among a clip AV stream, clip information, a clip, a playitem and a playlist;

FIG. 4 is a diagrammatic view illustrating a method of referring to the same clip from a plurality of playlists;

FIG. 5 is a diagrammatic view illustrating a sub path;

FIG. 6 is a block diagram illustrating a management structure of files recorded on a recording medium;

FIGS. 7A and 7B are block diagrams schematically illustrating operation of a BD virtual player;

FIG. 8 is a diagrammatic view schematically illustrating operation of the BD virtual player;

FIG. 9 is a diagrammatic view illustrating an example of a plane structure used in a display system of an image according to an embodiment of the present invention;

FIG. 10 is a block diagram showing a configuration of an example of synthesis of a moving picture plane, a subtitles plane and a graphics plane;

FIG. 11 is a view illustrating an example of a pallet table placed in a pallet;

FIGS. 12A to 12D are schematic views illustrating an example of a storage form of a button image;

FIG. 13 is a diagrammatic view illustrating an example of a state change of a button display displayed on the graphics plane;

FIGS. 14A to 14F are diagrammatic views schematically illustrating a configuration of menu screens and buttons;

FIG. 15 is a view illustrating syntax representative of an example of a structure of header information of an ICS;

FIG. 16 is a view illustrating syntax representative of an example of a structure of a block interactive_composition_data_fragment( );

FIG. 17 is a view illustrating syntax representative of an example of a structure of a block page( );

FIG. 18 is a view illustrating syntax representative of an example of a structure of a block button_overlap_group( );

FIG. 19 is a view illustrating syntax representative of an example of a structure of a block buttons;

FIG. 20 is a block diagram showing an example of a decoder model of interactive graphics;

FIG. 21 is a schematic view showing an example of a menu display image displayed based on an IG stream;

FIG. 22 is a schematic view illustrating a manner in which moving picture data reproduced by a playitem of a main path are displayed on the moving picture plane;

FIG. 23 is a schematic view showing an example of a display image produced by synthesis of a menu display image and moving picture data reproduced in accordance with the playitem of the main path and displayed on the moving picture plane;

FIG. 24 is a schematic view illustrating an example wherein a determination key is operated to display a pull-down menu;

FIG. 25 is a schematic view illustrating an example wherein a cross key or a like member is operated to display a pull-down menu;

FIG. 26 is a similar view but illustrating another example wherein a cross key or a like member is operated to display a pull-down menu;

FIG. 27 is a view illustrating examples of display control when a button is placed into an activated state where the examples are classified based on an object associated with the activated state of the button;

FIG. 28 is a flow chart illustrating an example of a method of performing display control of a button according to the embodiment of the present invention; and

FIG. 29 is a block diagram showing an example of a configuration of a reproduction apparatus which can be applied to the embodiment of the present invention.

### DETAILED DESCRIPTION OF THE PREFERRED EMBODIMENTS

In the following, an embodiment of the present invention is described with reference to the accompanying drawings. First, in order to facilitate understandings, a management structure of contents, that is, AV (Audio/Video) data, recorded on a BD-ROM which is a Blu-ray Disc of the read only type prescribed in the “Blu-ray Disc Read-Only Format Ver. 1.0 part 3 Audio Visual Specifications” relating to the Blue-ray Disc, is described. In the following description, the management structure in the BD-ROM is referred to as BDMV format.

A bit stream encoded in such a coding system as, for example, the MPEG (Moving Pictures Experts Group) video system or the MPEG audio system and multiplexed in accordance with the MPEG2 system is called clip AV stream or AV stream. A clip AV stream is recorded as a file on a disk by a file system defined by the “Blu-ray Read-Only Format part2” which is one of standards relating to the Blu-ray Disc. This stream is called clip AV stream file or AV stream file.

A clip AV stream file is a management unit on a file system and is not necessarily a management file which is easy to understand to a user. Where the convenience to a user is considered, it is necessary to record a mechanism for reproducing a video content divided into a plurality of clip AV stream files collectively as one video content, another mechanism for reproducing only part of a clip AV stream file, information for allowing special reproduction or cue search reproduction to be performed smoothly and like information as a database on a disk. The database is defined by the “Blu-ray Disc Read-Only Format part3” which is one of standards relating to the Blu-ray Disc.

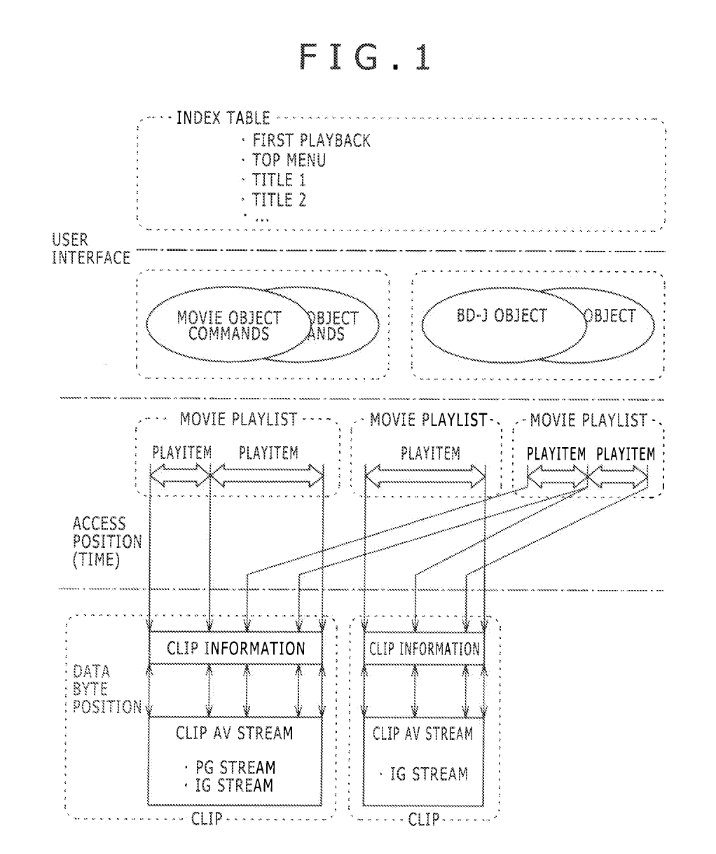

FIG. 1 schematically illustrates a data model of a BD-ROM. Referring to FIG. 1, the data structure of the BD-ROM includes four layers. The lowermost layer has clip AV streams placed therein and is hereinafter referred to as clip layer for the convenience of description. In an overlying layer, movie playlists (Movie Playlist) and play items (PlayItem) for designating a reproduction place for a clip AV stream are placed. The second lowermost layer is hereinafter referred to as playlist layer for the convenience of description. In a layer overlying the playlist layer, movie objects (Movie Object) and so forth which include commands for designating a reproduction order or the like regarding a movie playlist are placed. The third lowermost layer, that is, the second uppermost layer, is hereinafter referred to as object layer for the convenience of description. In the uppermost layer, an index table for managing titles and so forth stored on the BD-ROM is placed. The uppermost layer is hereinafter referred to as index layer for the convenience of description.

The clip layer is described. A clip AV stream is video data and/or audio data multiplexed in the MPEG2 TS (Transport Stream) format. Information relating to the clip AV stream is recorded as clip information (Clip Information) into a file.

In the clip AV stream, also a stream for displaying subtitles or a menu to be displayed incidentally to content data including video data and/or audio data is multiplexed. A graphics stream for displaying subtitles is called presentation graphics (PG) stream. Meanwhile, a stream into which data to be used for menu display are converted is called interactive graphics (IG) stream.

A clip AV stream file and a clip information file which has clip information corresponding to the clip AV stream file are regarded collectively as one object and referred to as clip (Clip). In other words, a clip is one object composed of a clip AV stream and clip information.

A file is usually handled as a byte string. A content of a clip AV stream file is developed on the time axis, and an entry point in a clip is designated principally based on time. If a timestamp of an access point to a predetermined clip is given, then a clip information file can be used in order to find out address information from which reading out of data is to be started in the clip AV stream file.

The playlist layer is described. A movie playlist includes a collection of a designation of an AV stream file to be reproduced, and a reproduction start point (IN point) and a reproduction end point (OUT point) which designate a reproduction portion of the designated AV stream file. One set of information of a reproduction start point and a reproduction end point is called playitem (PlayItem). A movie playlist is formed from a set of playitems. To reproduce a playitem is to reproduce part of an AV stream file referred to by the playitem. In particular, based on the IN point and the OUT point in the playitem, a corresponding portion in the clip is reproduced.

The object layer is described. A movie object includes terminal information representative of linkage between an HDMV navigation command program (HDMV program) and a movie object. The HDMV program is commands for controlling reproduction of a playlist. The terminal information includes information for permitting an interactive operation of a user to a BD-ROM player. Based on the terminal information, such user operation as calling of a menu screen image or title search is controlled.

A BD-J object includes an object according to a Java (registered trademark) program. Since the BD-J object does not have much relation to the present invention, detailed description thereof is omitted herein.

The index layer is described. The index layer includes an index table. The index table is a table of the top level which defines the title of the BD-ROM disk. Based on title information placed in the index table, reproduction of the BD-ROM disk is controlled by a module manager in system software resident in the BD-ROM.

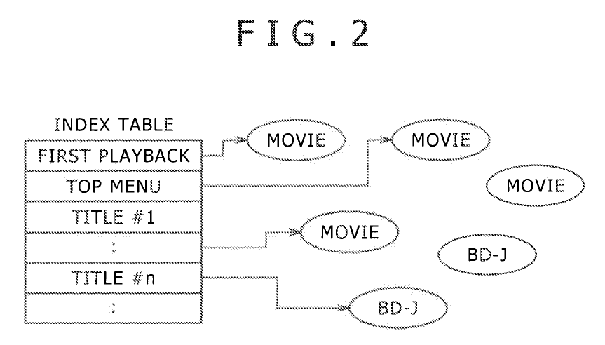

In particular, as generally illustrated in FIG. 2, an entry in an index table is called title, and all of First Playback, Top Menu and Title #1 to Title #n entered in the index table are titles. Each title indicates a link to a movie object or a BD-H object and indicates either an HDMV title or a BD-J title.

For example, the First Playback is, if a content stored in the BD-ROM is a movie, advertising images (trailer) of a movie company displayed prior to display of the body of the movie. The Top Menu is, for example, if a content stored in the BD-ROM is a movie, a menu screen image for selecting reproduction of the body part, chapter search, setting of subtitles or the language, special favor image reproduction and so forth. Further, a title is an image selected from the top menu. It is possible to configure a title as a menu screen image.

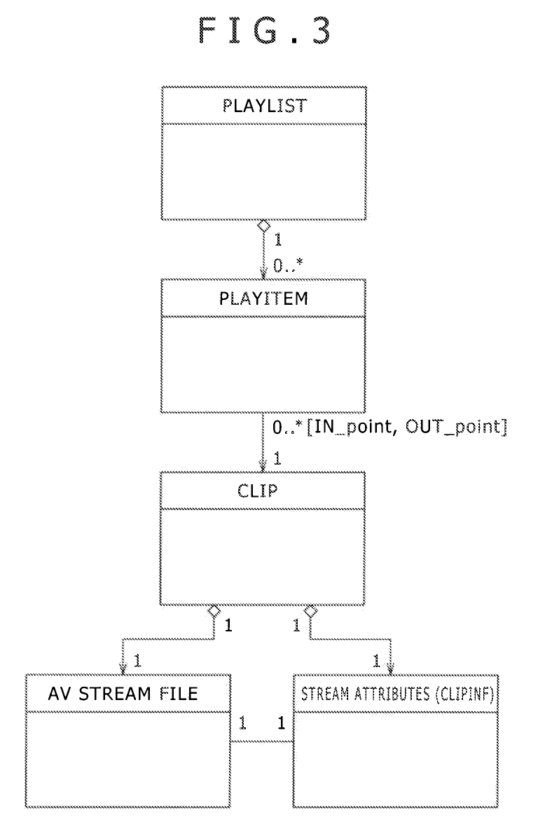

FIG. 3 is a view of the UML (Unified Modeling Language) illustrating a relationship among such a clip AV stream, clip information (Stream Attributes), a clip, a playitem and a playlist. A playlist is associated with one or a plurality of playitems, and a playitem is associated with one clip. It is possible to associate one clip with a plurality of playitems which have different start points and/or end points. One clip AV stream is referred to from one clip. Similarly, one clip information file is referred to from one clip. Further, a clip AV stream file and a clip information file have a one-to-one corresponding relationship to each other. By such a structure as described above, nondestructive reproduction order designation of reproducing only arbitrary portions without changing the clip AV stream file can be performed.

Also it is possible to refer to the same clip from a plurality of playlists as seen in FIG. 4. Further, also it is possible to designate a plurality of clips from one playlist. A clip is referred to with the IN point and the OUT point indicated by a playitem in a playlist. In the example of FIG. 4, a clip 500 is referred to from a playitem 520 of a playlist 510, and an interval of the clip 500 indicated by an IN point and an OUT point is referred to from a playitem 521 from between playitems 521 and 522 which form a playlist 511. Meanwhile, an interval of another clip 501 indicated by an IN point and an OUT point is referred to from a playitem 522 of the playlist 511, and another interval of the clip 501 indicated by an IN point and an OUT point of a playitem 523 from between playitems 523 and 524 of a playlist 512 is referred to.

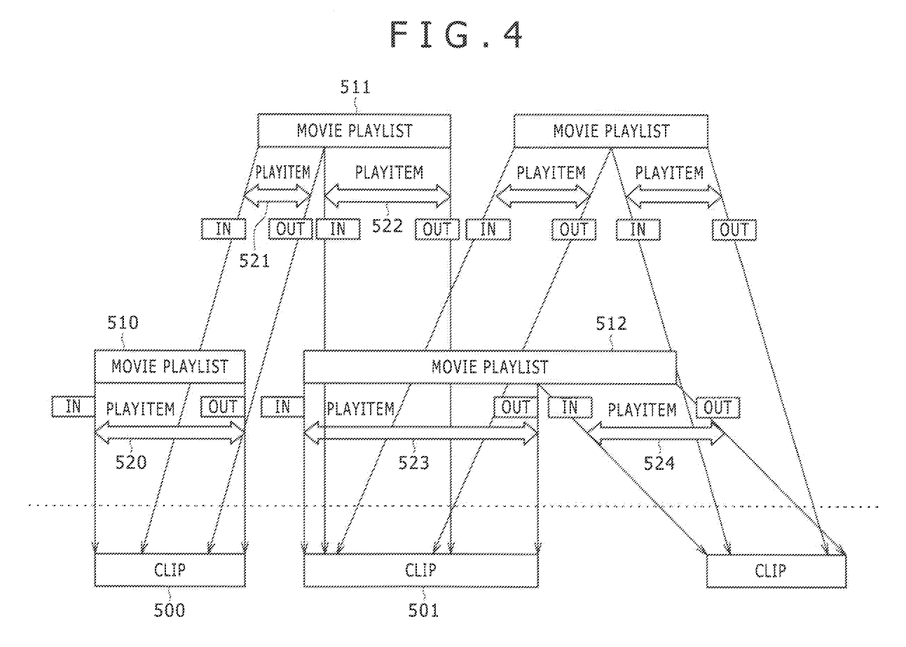

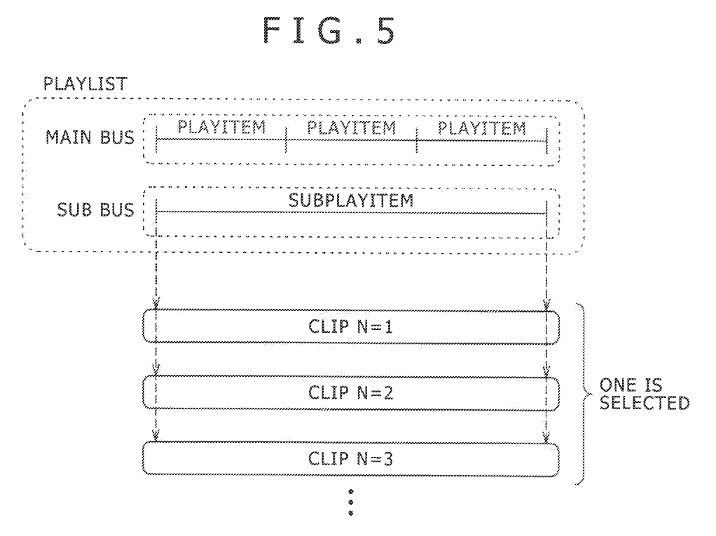

It is to be noted that, as seen in FIG. 5 which shows an example of a playlist, a playlist can have a sub path corresponding to a sub playitem with respect to a main path corresponding to a playitem which is produced principally. A sub playitem can be associated with a plurality of different clips and can selectively refer to one of the plural clips associated therewith. Although detailed description is omitted, a playlist can have a sub playitem only when it satisfies a predetermined condition.

Now, a management structure of files recorded in a BD-ROM, which is prescribed by the “Blu-ray Disc Read-Only Format part3” is described with reference to FIG. 6. Files are managed hierarchically through a directory structure. On the recording medium, one directory (in the example of FIG. 6, a root directory) is produced first. This directory provides a range within which one recording and reproduction system performs management.

Under the root directory, a directory “BDMV” and another directory “CERTIFICATE” are placed. In the directory “CERTIFICATE”, information relating to the copyright is placed. In the directory “BDMV”, the data structure described hereinabove with reference to FIG. 1 is placed.

Immediately under the directory “BDMV”, only two files can be placed including a file “index.bdmv” and another file “MovieObject.bdmv”. Further, under the directory “BDMV”, directories “PLAYLIST”, “CLIPINF”, “STREAM”, “AUXDATA”, “META”, “BDJO”, “JAR” and “BACKUP” are placed.

The file “index.bdmv” describes the substance of the directory BDMV. In particular, this file “index.bdmv” corresponds to the index table in the index layer which is the above-described uppermost layer. Meanwhile, the file “MovieObject.bdmv” has information of one or more movie objects placed therein. In other words, the file “MovieObject.bdmv” corresponds to the object layer described hereinabove.

The directory “PLAYLIST” has a database of playlists placed therein. In particular, the directory “PLAYLIST” includes files “xxxxx.mpls” which relate to movie playlists. A file “xxxxx.mpls” is produced for each of movie playlists. The “xxxxx” preceding to the period “.” in the file name is a numeral of five digits, and the “mpls” succeeding the period is an extension fixed for files of the type described.

The directory “CLIPINF” has a database of clips placed therein. The directory “CLIPINF” includes files “zzzzz.clpi” which are clip information files relating to clip AV stream files. A file “zzzzz.clpi” is produced for each of clip information files. The “zzzzz” preceding to the period “.” in the file name is a numeral of five digits, and the “clpi” succeeding the period is an extension fixed for files of the type described.

The directory “STREAM” has AV stream files as an entity placed therein. In particular, the directory “STREAM” includes a clip AV stream file corresponding to each clip information file. A clip AV stream file is formed from a transport stream (hereinafter referred to as MPEG2 TS) of the MPEG2 (Moving Pictures Experts Group 2) and has a file name of “zzzzz.m2ts”. The “zzzzz” preceding to the period in the file name is same as that of the file name of a corresponding flip information file so that a relationship between the clip information file and the clip AV stream file can be grasped readily.

In the directory “AUXDATA”, a sound file, a font file, a font index file, a bitmap file and so forth which are used for menu display are placed. In a file “sound.bdmv”, sound data relating to an application of an interactive graphics stream of the HDMV is placed. The file name is fixed to “sound.bdmv”. In another file “aaaaa.otf”, font data used in a subtitles display image, the BD-J application described hereinabove and so forth are placed. The “aaaaa” preceding to the period in the file name is a numeral of five digits, and the “otf” following the period is an extension fixedly used for files of this type. A file “bdmv.fontindex” is an index file of the fonts.

The directory “META” has a meta data file placed therein. In the directories “BDJO” and “JAR”, files relating to the BD-J object described hereinabove are placed. Meanwhile, in the directory “BACKUP”, backup data of the directories and files described above are placed. Since the directories “META”, “BDJO”, “JAR” and “BACKUP” mentioned above do not have direct relation to the subject matter of the present invention, detailed description thereof is omitted herein.

If a disk having such a data structure as described above is loaded into a player, then it is necessary for the player to convert commands described in a movie object or the like read out from the disk into unique commands for controlling the hardware in the player. The player stores software for performing such conversion in advance in a ROM (Read Only Memory) built in the player. This software is called BD virtual player since it causes the player to operate in accordance with the standards for the BD-ROM through the disk and the player.

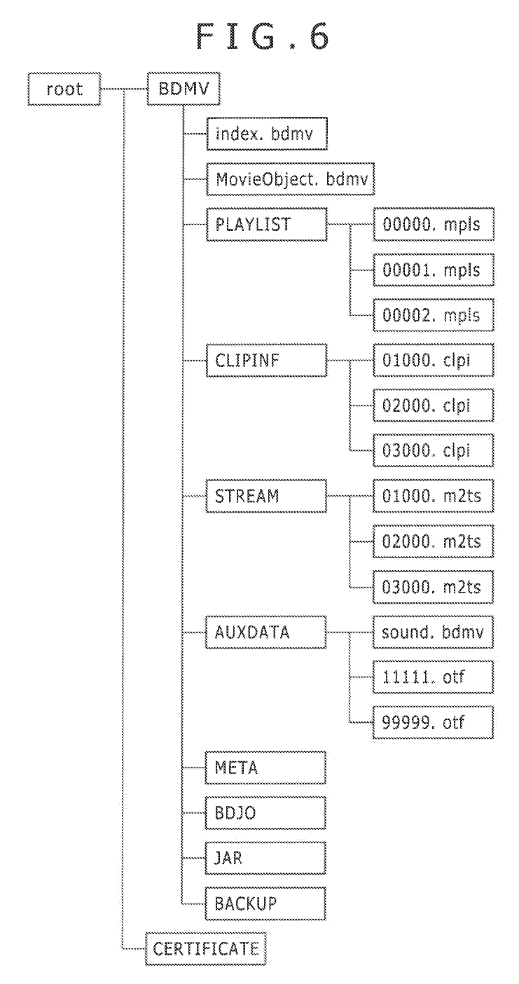

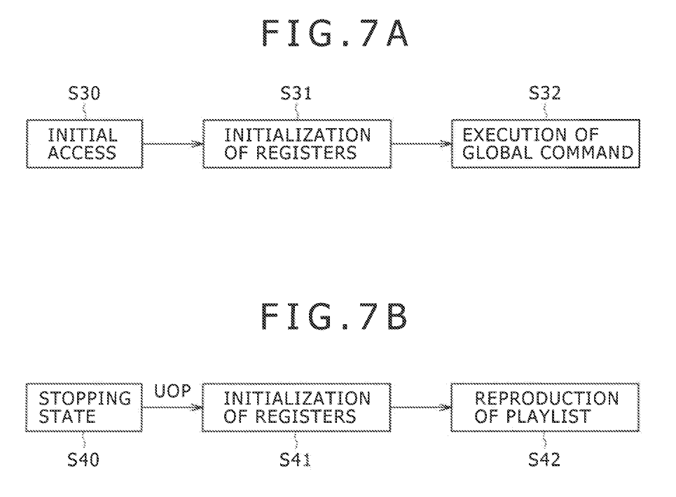

FIGS. 7A and 7B schematically illustrate operation of the BD virtual player. FIG. 7A illustrates an example of operation upon loading of a disk. If a disk is loaded into the player and the player performs initial accessing for the disk (step S30), then registers into which shared parameters to be used in a shared fashion with one disk are initialized (step S31). Then, at next step S32, a program is read in from the disk and executed. It is to be noted that the initial accessing is reproduction of the disk performed for the first time upon loading of the disk or the like.

FIG. 7B illustrates an example of operation when, for example, a play key is depressed by a user to issue a reproduction instruction while the player is in a stopping state. Referring to FIG. 7B, in a first stopping state (step S40), a reproduction instruction is issued using, for example, a remote control commander (UO: User Operation) by a user. In response to the issuance of the reproduction instruction, registers, that is, common parameters, are initialized (step S41). Then at next step S42, a playlist reproduction phase is entered. It is to be noted that the system may be configured otherwise such that the registers are not reset.

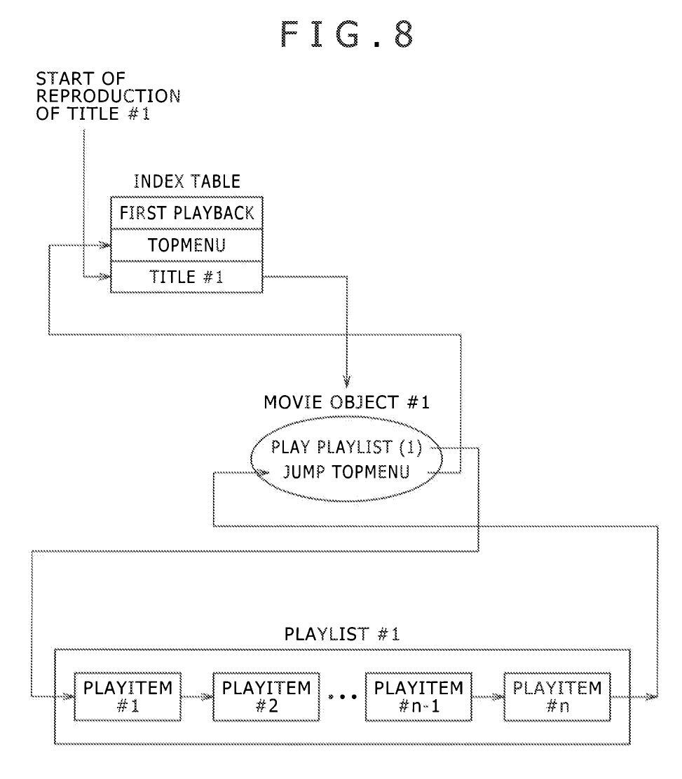

Reproduction of a playlist in an activation phase of a movie object is described with reference to FIG. 8. A case is considered wherein an instruction to start reproduction of a content of the title number #1 is issued in response to a UO or the like. The player refers to the index table (Index Table) illustrated in FIG. 2 in response to the reproduction starting instruction of the content to acquire the number of the object corresponding to the content reproduction of the title #1. For example, if the number of the object for implementing the content reproduction of the title #1 is #1, then the player starts activation of the movie object #1.

In the example of FIG. 8, if the program described in the movie object #1 includes two lines and the command of the first line is “Play PlayList(1)”, then the player starts reproduction of the playlist #1. The playlist #1 is formed from one or more playitems, which are reproduced successively. After the reproduction of the playitems in the playlist #1 comes to an end, the player returns to activation of the movie object #1 and executes the command of the second line. In the example of FIG. 8, the command of the second line is “jump TopMenu” and is executed to start activation of a movie object which implements the top menu (Top Menu) described in the index table.

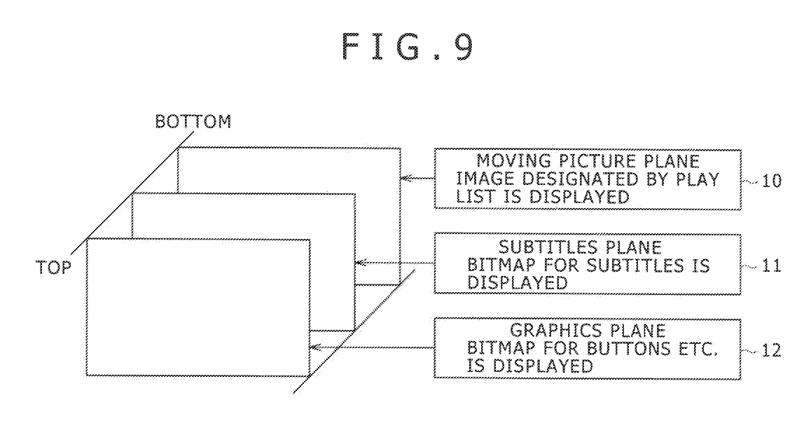

Now, an image display system which can be applied to an embodiment of the present invention is described. In the embodiment of the present invention, the image display system assumes such a plane configuration as shown in FIG. 9. Referring to FIG. 9, a moving picture plane 10 is displayed on the rearmost side or bottom and handles an image (principally moving picture data) designated by the playlist. A subtitles plane 11 is displayed on the moving picture plane 10 and handles subtitles data which are displayed during reproduction of moving pictures. A graphics plane 12 is displayed on the frontmost side and handles graphics data such as character data for displaying a menu screen and bitmap data for a button image. One display screen image to be displayed is formed from three such planes as mentioned above.

It is to be noted that, since the graphics plane 12 handles data for displaying a menu screen in this manner, it is hereinafter referred to as interactive graphics plane 12.

The moving picture plane 10, subtitles plane 11 and interactive graphics plane 12 can be displayed independently of each other. The moving picture plane 10 has a resolution of 1,920 pixels×1,080 lines with a data length of 16 bits per one pixel and uses a system of a luminance signal Y and color difference signals Cb and Cr of 4:2:2 (hereinafter referred to as YCbCr(4:2:2). It is to be noted that the YCbCr(4:2:2) system is a color system wherein, per one pixel, the luminance signal Y is represented by 8 bits while each of the color difference signals Cb and Cr is represented by eight bits and it is regarded that the color difference signals Cb and Cr form one color data in horizontally two pixels. The interactive graphics plane 12 and the subtitles plane 11 have a resolution of 1,920 pixels×1,080 lines with a sampling depth of 8 bits for each pixel and uses, as a color system, an 8-bit color map address system which uses a pallet of 256 colors.

The interactive graphics plane 12 and the subtitles plane 11 allow alpha blending of 256 stages and allow setting of the opacity among 256 stages upon synthesis to another plane. The setting of the opacity can be performed for each pixel. In the following description, it is assumed that the opacity α is represented within a range of 0≦α≦1 and the opacity α=0 represents full transparency while the opacity α=1 represents full opacity.

The subtitles plane 11 handles image data, for example, of the PNG (Portable Network Graphics) format. Also the interactive graphics plane 12 can deal with image data, for example, of the PNG format. According to the PNG format, the sampling depth of one pixel ranges from 1 bit to 16 bits, and where the sampling depth is 8 bits or 16 bits, an alpha channel, that is, opacity information (called alpha data) of each pixel component can be added. Where the sampling depth is 8 bits, the opacity can be designated among 256 stages. Alpha blending is performed using opacity information by the alpha channel. Further, a pallet image of up to 256 colors can be used, and it is represented by an index number what numbered element (index) of a pallet prepared in advance the element is.

It is to be noted that image data handled by the subtitles plane 11 and the interactive graphics plane 12 are not limited to those of the PNG format. Also image data compression coded by another compression coding system such as the JPEG system, run-length compressed image data, bitmap data which are not in a compression coded form or like data may be handled.

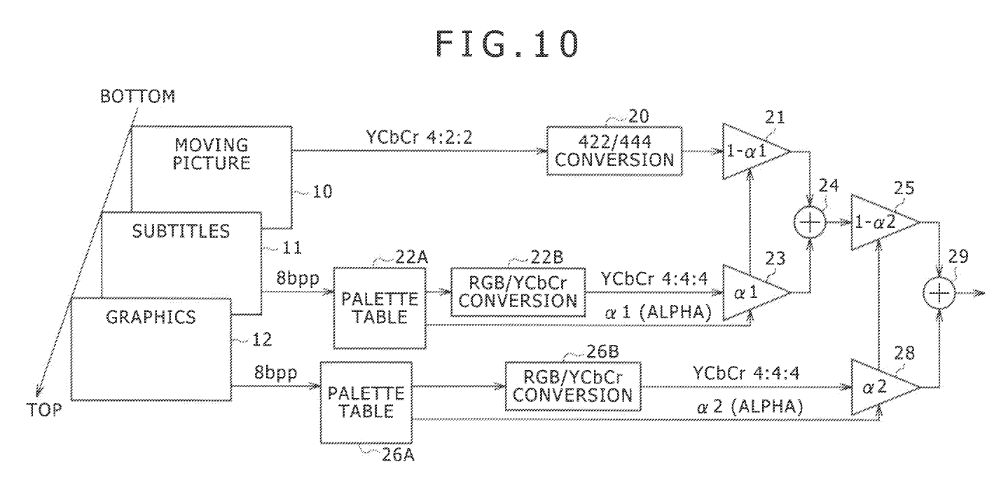

FIG. 10 illustrates an example of a configuration of a graphics processing section for synthesizing the three planes in accordance with the plane configuration described hereinabove with reference to FIG. 9. It is to be noted that the configuration shown in FIG. 10 can be implemented by any of hardware and software. Animation data of the moving picture plane 10 are supplied to a 422/444 conversion circuit 20. The video data are converted, in terms of the color system thereof, from YCbCr(4:2:2) into YCbCr(4:4:4), and resulting data are inputted to a multiplier 21.

Image data to the subtitles plane 11 are inputted to a palette 22A, from which they are outputted as image data of RGB(4:4:4). Where the opacity by alpha blending is designated for the image data, the designated opacity α1 (0≦α1≦1) is outputted from the palette 22A.

In the palette 22A, pallet information corresponding to a file, for example, of the PNG format is stored as a table. In the palette 22A, an index number is referred to using the inputted image data of 8 bits as an address. Based on the index number, data of RGB(4:4:4) each formed from data of 8 bits are outputted. Further, data a of the alpha channel representative of the opacity is extracted from the palette 22A.

FIG. 11 illustrates an example of the pallet table placed in the palette 22A. To each of 256 color index values [0x00] to [0xFF] ([0x] represents a hexadecimal notation), values R, G and B of the three primary colors and the opacity α each represented by 8 bits are allocated. In the palette 22A, the pallet table is referred to based on an index value designated by inputted image data of the PNG format, and data (RGB data) of the colors of R, G and B and the opacity α which are each formed from 8-bit data and correspond to the index value designated by the image data are outputted for each pixel.

Referring back to FIG. 10, the RGB data outputted from the palette 22A are supplied to an RGB/YCbCr conversion circuit 22B, by which they are converted into data of a luminance signal Y and color difference signals Cb and Cr which have a data length of 8 bits (the data are hereinafter referred to collectively as YCbCr data). This is because it is necessary to perform later synthesis among the planes in a common data format, and to this end, YCbCr data of the data format used by video data are used commonly.

The YCbCr data and the opacity data α1 outputted from the RGB/YCbCr conversion circuit 22B are inputted to a multiplier 23. The multiplier 23 multiplies the YCbCr data and the opacity data α1 inputted thereto. A result of the multiplication is inputted to one of input terminals of an adder 24. It is to be noted that the multiplier 23 performs multiplication of the opacity data α1 for each of the luminance signal Y and the color difference signals Cb and Cr of the YCbCr data. Further, a complement (1−α1) to the opacity data α1 is supplied to the multiplier 21.

The multiplier 21 multiplies the video data inputted from the 422/444 conversion circuit 20 by the complement (1−α1) to the opacity data α1. A result of the multiplication is inputted to the other input terminal of the adder 24. The adder 24 adds the multiplication results of the multipliers 21 and 23. Consequently, the moving picture plane 10 and the subtitles plane 11 are synthesized. A result of the addition of the adder 24 is inputted to a multiplier 25.

Image data of the interactive graphics plane 12 are inputted to a palette 26A, from which they are outputted as image data of RGB(4:4:4). Where an opacity by alpha blending is designated for the image data, the designated opacity α2 (0≦α2≦1) is outputted from the palette 26A. The RGB data outputted from the palette 26A are supplied to an RGB/YCbCr conversion circuit 26B, by which they are converted into YCbCr data. Consequently, the data format is unified into that of YCbCr data which is the data format of video data. The YCbCr data outputted from the RGB/YCbCr conversion circuit 26B are inputted to a multiplier 28.

Where image data used in the interactive graphics plane 12 are of the PNG format, the opacity data α2 (0≦α≦1) can be set for each pixel in the image data. The opacity data α2 are supplied to the multiplier 28. The multiplier 28 performs multiplication of each of the luminance signal Y and the color difference signals Cb and Cr of the YCbCr data inputted thereto from the RGB/YCbCr conversion circuit 26B by the opacity data α2. A result of the multiplication by the multiplier 28 is inputted to one of input terminals of an adder 29. Further, a complement (1−α2) to the opacity data α2 is supplied to the multiplier 25.

The multiplier 25 multiplies the addition result of the adder 24 by the complement (1−α2) to the opacity data α2. A result of the multiplication is inputted to the other input terminal of the adder 29, by which it is added to the multiplication result of the multiplier 28 described hereinabove. Consequently, the interactive graphics plane 12 is synthesized further with the result of the synthesis of the moving picture plane 10 and the subtitles plane 11.

If the opacity α, for example, in a region of the subtitles plane 11 or the interactive graphics plane 12 which does not include an image to be displayed is set to α=0, then a plane to be displayed under the plane can be displayed transparently. For example, video data displayed on the moving picture plane 10 can be displayed as the background to the subtitles plane 11 or the interactive graphics plane 12.

Now, the interactive graphics stream (IG stream) is described. Here, attention is paid to a portion of an IG stream which has much relation to the present invention. The IG stream is a data stream used for menu display as described hereinabove. For example, a button image to be used in menu display is placed in the IG stream.

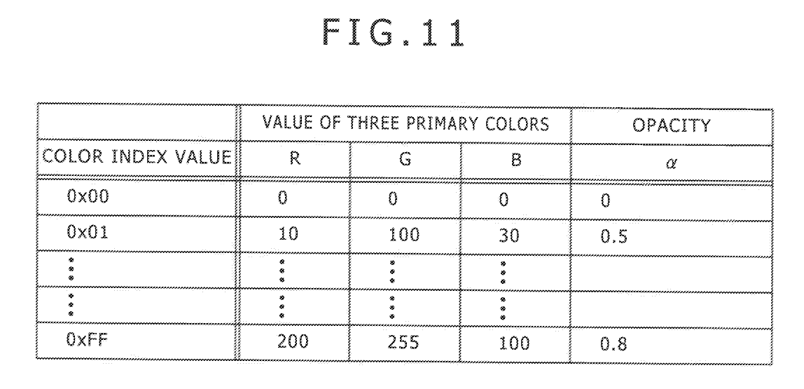

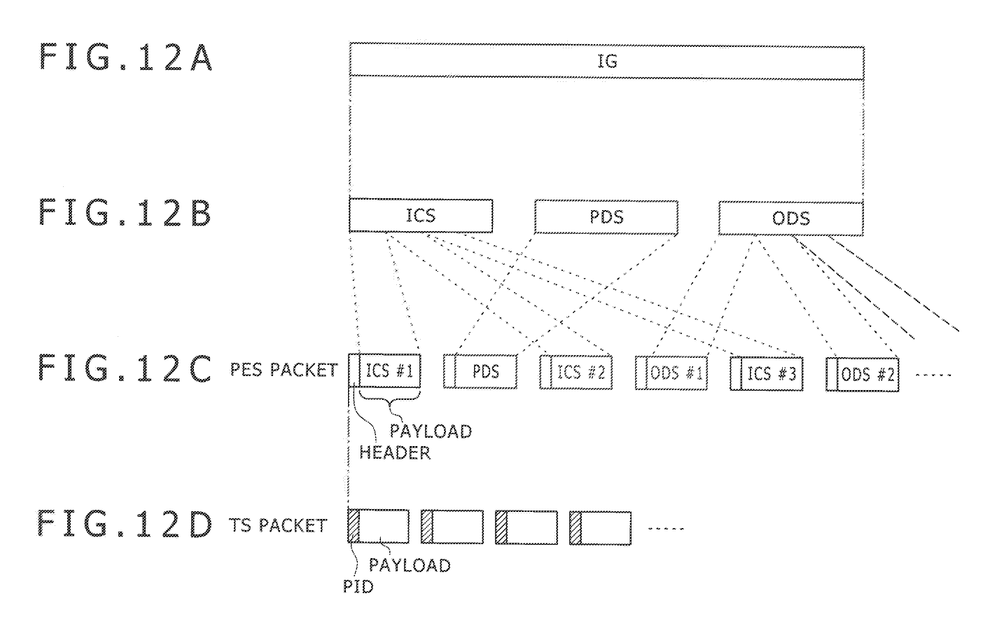

The IG stream is multiplexed in a clip AV stream. An interactive graphics stream (refer to FIG. 12A) is formed from, as seen in FIG. 12B which illustrates an example of the interactive graphics stream, three different segments of an ICS (Interactive Composition Segment), a PDS (Palette Definition Segment) and an ODS (Object Definition Segment).

Of the three segments, the ICS is a segment for retaining a basic structure of IG (Interactive Graphics) while details are hereafter described. The PDS is a segment for retaining color information of a button image. The ODS is information for retaining the shape of a button. More particularly, in the ODS, a button image itself, for example, bitmap data for displaying the button image, is placed in a form compression coded by a predetermined compression coding method such as run-length compression.

The ICS, PDS and ODS are individually divided, as seen in FIG. 12 in which one example of them is illustrated, into blocks as occasion demands and are placed into the payload of PES (Packetized Elementary Stream) packets which are identified from each other with PID (Packet Identification). Since it is prescribed that a PES packet has a size of 64 KB (kilobytes), the ICS and the ODS which have a comparatively great size are divided in a predetermined size and placed into the payload of PES packets. Meanwhile, since the PDS in most cases has a size of less than 64 KB, a PDS for one IG can be placed into one PES packet. In each PES packet, information representing which one of an ICS, a PDS and an ODS the data placed in the payload is, identification information representative of an order number of the packet and so forth are placed into a PID.

Each of the PES packets is further divided in a predetermined manner and stuffed into transport packets of an MPEG TS (transport stream) (FIG. 12D). An order number of each transport packet, identification information for identifying data placed in each transport packet and so forth are placed in the PID of the packet.

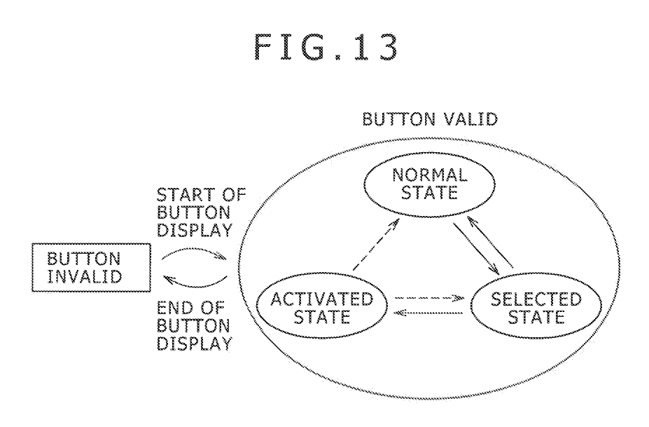

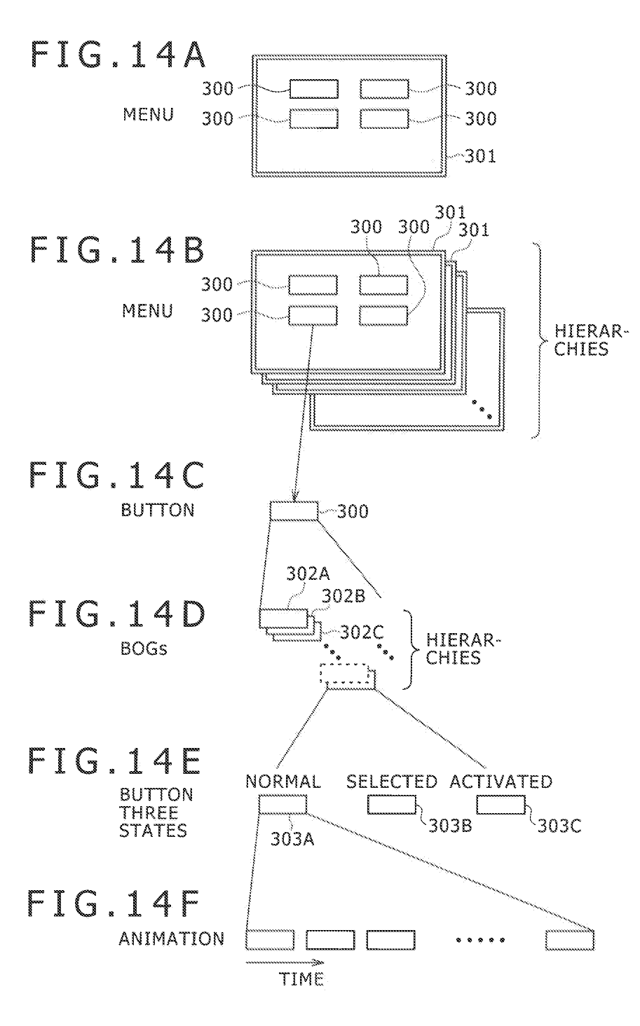

Now, the ICS included in the display set (DisplaySet) of interactive graphics is described. Prior to the description of the ICS, a configuration of a menu screen image and a button are described with reference to FIGS. 13 and 14A to 14F. It is to be noted that the display set is, in the case of an IG stream, a set of data for performing menu display. A display set of an IG stream is formed from an ICS, a PDS and an ODS described hereinabove.

FIG. 13 illustrates an example of state change of a button display image displayed on the interactive graphics plane 12. Buttons involved generally have two states including an invalid state and a valid state, and in the invalid state, no button is displayed on the screen, but in the valid state, button display is performed. When change from the button invalid state to the button valid state is performed, button display is started. When change from the button valid state to the button invalid state is performed, the button display is ended. The button valid state has three different states including a normal state, a selected state and an activated state. Button display can change among the three different states. Also it is possible to restrict the transition direction to one direction. Further, an animation can be defined for each of the three button display states.

FIGS. 14A to 14F schematically illustrate a configuration of a menu screen image and buttons. Such a menu screen image 301 on which a plurality of buttons 300 are disposed as shown in FIG. 14A is considered. As seen in FIG. 14B, the menu screen image 301 can be formed hierarchically from a plurality of menu screen images. Each of the menu screen images is called page. For example, if a certain button 300 of a menu screen image displayed on the frontmost side is placed from the selected state into the activated state using a predetermined inputting mechanism, then another menu screen image positioned immediately rearwardly of the menu screen image may come to the frontmost side. It is to be noted that, in the following description, “to change the state of a button by means of the predetermined inputting mechanism” is sometimes represented as “to operate a button” or the like in order to avoid complicated description.

One button 300 displayed on the menu screen image 301 may have a hierarchical structure of a plurality of buttons 302A, 302B, . . . (refer to FIGS. 14C and 14D). This signifies that a plurality of buttons can be selectively displayed at one button display position. For example, in such a case that, when a predetermined one of a plurality of buttons is operated, the function and the display of several ones of the other buttons displayed simultaneously are changed, the hierarchical structure is used advantageously in that there is no necessity to rewrite the menu screen image itself. Such a set including a plurality of buttons displayed selectively at one button position as just described is hereinafter referred to as BOGs (Button Overlap Group).

Each of buttons which compose a BOGs can assume three states including a normal state, a selected state and an activated state. In particular, as seen in FIG. 14e which shows an example of a BOGs, buttons 303A, 303B and 303C representative of the normal state, selected state and activated state, respectively can be prepared for each of the buttons of the BOGs. Furthermore, an animation display can be set to each of the buttons 303A, 303B and 303C which represent the three states as seen in FIG. 14F which illustrates an example of such animation displays. In this instance, a button to which animation displays are set is formed from a number of button images which are to be used for the animation displays.

It is to be noted that, in the following description, each of a plurality of button images which form an animation of a button is suitably referred to as animation frame.

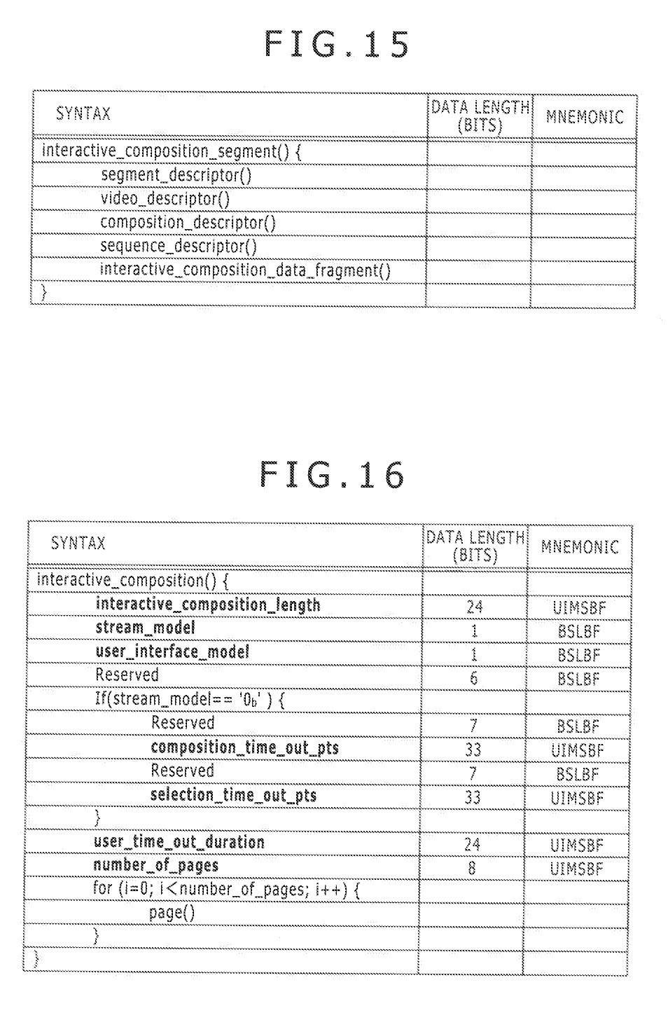

FIG. 15 illustrates syntax representative of an example of a structure of header information of the ICS. Referring to FIG. 15, the header of the ICS includes blocks segment_descriptor( ), video_descriptor( ), composition_descriptor( ), sequence_descriptor( ) and interactive_composition_data_fragment( ). The block segment_descriptor( ) represents that the segment is the ICS. The block video_descriptor( ) represents a frame rate or a screen frame size of a video to be displayed simultaneously with the menu. The block composition_descriptor( ) includes a field composition_state (not shown) and represents a status of the ICS. The block sequence_descriptor( ) represents whether or not the ICS extends over a plurality of PES packets.

More particularly, this block sequence_descriptor( ) represents at which one of the head and the tail of one IG stream the ICS included in the current PES packet is positioned.

In particular, if the data size of the ICS is greater than that of a PES packet whose data size is fixed to 64 KB as described above, then the ICS is divided into a predetermined manner and placed into PES packets. At this time, the header part illustrated in FIG. 15 may be included only in PES packets at the head and the tail from among those packets in which the ICS is placed divisionally while it is omitted in the remaining intermediate PES packets. If this block sequence_descriptor( ) indicates the head and the tail, then it can be recognized that the ICS is placed in one PES packet.

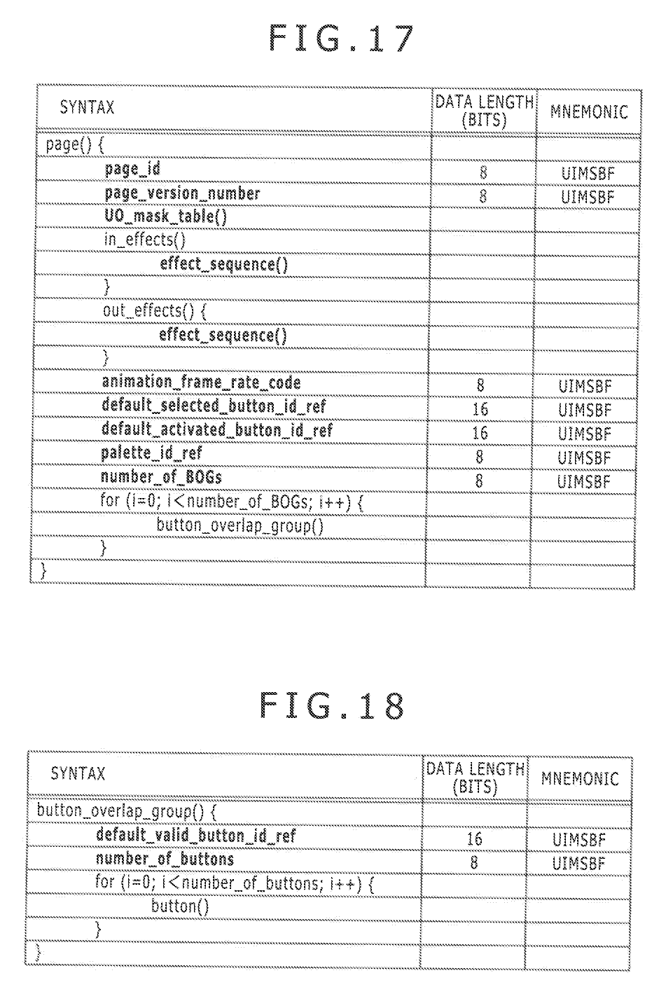

FIG. 16 illustrates syntax representative of an example of a structure of the block interactive_composition_data_fragment( ). It is to be noted that, in FIG. 16, the block itself is represented as block interactive_composition( ). The field interactive_composition_length has a data length of 24 bits, and the block interactive_composition( ) represents the length of a portion following the field interactive_composition_length. The field stream_model has a data length of 1 bit and represents whether or not the stream is in a multiplexed state.

If the value of the field stream_model is “0”, then this represents that the stream is in a multiplexed state and indicates that there is the possibility that another related elementary stream may be multiplexed together with the interactive graphics stream in the MPEG2 transport stream. If the value of the field stream_model is “1”, then this represents that the stream is not in a multiplexed state and indicates that only the interactive graphics stream exists in the MPEG2 transport stream. In other words, not only it is possible to multiplex an interactive graphics stream with an AV stream but also it is possible to form a clip AV stream only from an AV stream. It is to be noted that an interactive graphics stream in a non-multiplexed state is defined only as an asynchronous sub path.

The field user_interface_model has a data length of 1 bit and represents whether a menu to be displayed based on the stream is a popup menu or a normally displayed menu. The popup menu is a menu which can control presence/absence of display by a predetermined inputting mechanism such as, for example, on/off of a button on a remote control commander. Meanwhile, it cannot be controlled by a user operation whether or not the normally displayed menu should be displayed. When the field user_interface_model has the value “0”, it represents the popup menu, but when it has the value “1”, it represents the normally displayed menu. It is to be noted that the popup menu is permitted only when the value of the field stream_model is “1” and the stream is not in a multiplexed state with another elementary stream.

If the value of the field stream_model is “0”, then the field composition_time_out_pts and the field selection_time_out_pts following an IF statement If(stream_model==“0_{b}” are validated. The field composition_time_out_pts has a data length of 33 bits and indicates a timing at which a selection operation on the menu display is to be disabled. The timing is described in a PTS (Presentation Time Stamp) prescribed in the MPEG2.

FIG. 17 illustrates syntax representing an example of a structure of the block page( ). The field page_id has a data length of 8 bits and represents an ID for identifying the page. The field page_version_number has a data length of 8 bits and represents a version number of the page. The next block UO_mask_table( ) represents a table in which operations (UO: User Operation) of the inputting mechanism by a user which are inhibited during display of the page are described.

The block in_effect( ) represents an animation block to be displayed when this page is displayed. A sequence of animations is described in the block effect_sequence( ) in the parentheses { }. Meanwhile, the block out_effect( ) represents an animation block to be displayed when this page ends. A sequence of animations is described in the block effect_sequence( ) in the parentheses { }. The blocks in_effect( ) and out_effect( ) are animations activated where this ICS is found out when the page moves.

The next field animation_frame_rate_code has a data length of 8 bits and represents a setting parameter of an animation frame rate where a button image of this page is to be animated. For example, where the frame rate of video data in a clip AV stream file to which the ICS corresponds is represented by V_{frm} and the animation frame rate is represented by A_{frm}, the value of the field animation_frame_rate_code can be represented by a ratio between them like V_{frm}/A_{frm}.

The field default_selected_button_id_ref has a data length of 16 bits and represents an ID for designating a button to be placed into a selected state first when the page is displayed. Further, the next field default_activated_bottom_id_ref has a data length of 16 bits and represents an ID for designating a button to be placed into an activated state automatically when time indicated by the field selection_time_out_pts described hereinabove with reference to FIG. 16 is reached.

The field patette_id_ref has a data length of 8 bits and represents an ID of a palette to which this page is to refer. In other words, color information in the PDS in the IG stream is designated by the field palette_id_ref.

The next field number_of_BOGs has a data length of 8 bits and indicates the number of BOGs used in this page. A loop beginning with a next for state is repeated by a number of times indicated by the field number_of_BOGs, and definition is made for each BOGs by the block button_overlap_group( ).

FIG. 18 represents syntax representative of an example of a structure of the block button_overlap_group( ). Referring to FIG. 18, the field default_valid_button_id_ref has a data length of 16 bits and represents an ID of a button to be displayed first in a BOGs defined by the block button_overlap_group( ). The next field number_of_buttons has a data length of 8 bits and represents the number of buttons to be used in the BOGs. Then, a loop beginning with a next for statement is repeated by a number of times indicated by the field number_of_buttons, and definition of the buttons is made by the block buttons.

As described hereinabove, a BOGs can have a plurality of buttons, and the structure of each of a plurality of buttons which the BOGs has is defined by the block button( ). The button structure defined by the block button( ) is displayed actually.

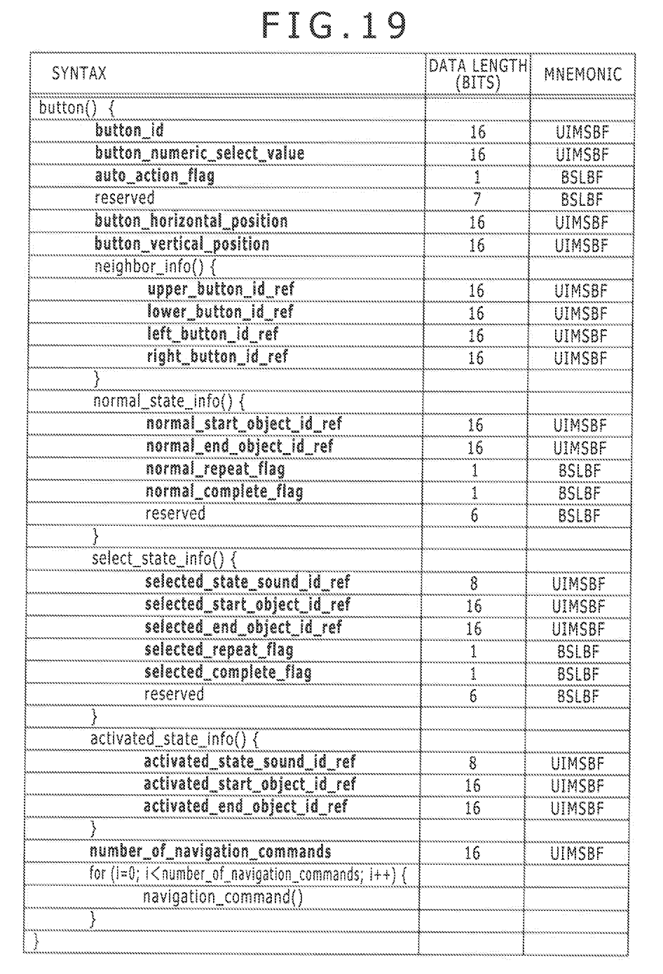

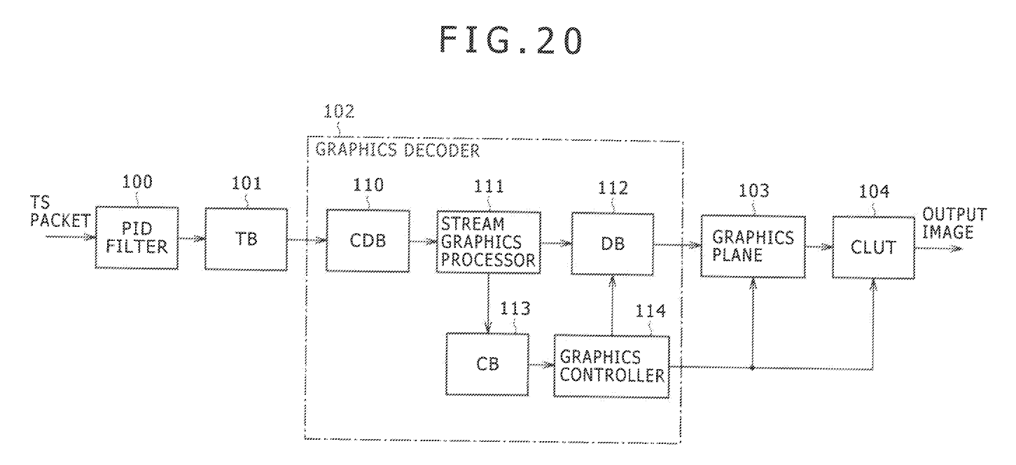

FIG. 19 illustrates syntax representative of an example of a structure of the block button( ). Referring to FIG. 19, the field button_id has a data length of 16 bits and represents an ID for identifying this button. The field button_numeric_select_value has a data length of 16 bits and represents to what numbered numeric key on the remote control commander the button is allocated. The flag auto_action_flag is a flag having a data length of 1 bit and indicates whether or not, when this button is placed into the selected state, a function allocated to the button is to be executed automatically.

It is to be noted that, in the following description, a button defined such that, when the selected state is established by the flag auto_action_flag, a function allocated to the button is executed automatically is suitably referred to as automatic action button.

Next fields button_horizontal_position and button_vertical_position have a data length of 16 bits and represent the position in the horizontal direction and the position (height) in the vertical position on the screen image on which the button is displayed.

The block neighbor_info( ) represents peripheral information of the button. In particular, the value in the block neighbor_info( ) represents a button which is to be placed into the selected state when a direction key on the remote control commander by which an instruction of the upward, downward, leftward or rightward direction can be issued is operated in a state wherein the button is in the selected state. Among fields in the block neighbor_infor( ), the fields upper_button_id_ref, lower_button_id_ref, left_button_id_ref and right_button_id_ref having a data length of 16 bits represent IDs of buttons which are to be placed into the selected state when an operation indicating the upward, downward, leftward or rightward direction is performed, respectively.

The succeeding blocks normal_state_info( ), selected_state_info( ) and activated_state_info( ) represent information in the normal, selected and activated states, respectively.

First, the block normal_state_info( ) is described. The fields normal_start_object_id_ref and normal_end_object_id_ref having a data length of 16 bits represent IDs which designate objects at the head and the tail of animations of the button in the normal state, respectively. In other words, a button image (that is, an animation frame) used for an animation image of the buttons is designated for the corresponding ODS by the fields normal_start object_id_ref and normal_end_object_id_ref.

The next flag normal_repeat_flag has a data length of 1 bit and represents whether or not the animation of the button should be repeated. For example, when the value of the flag normal_repeat_flag is “0”, it indicates that the animation of the button should not be repeated, but when it is “1”, it indicates that the animation of the button should be repeated. The next flag normal_complete_flag has a data length of 1 bit and controls the animation operation when the state of the button changes from the normal state to the selected state.

Now, the block selected_state_info( ) is described. This block selected_state_info( ) is the block normal_state_info( ) described hereinabove to which the field selected_state_sound_id_ref for indicating sound is added. The field selected_state_sound_id_ref has a data length of 8 bits and represents a sound file which is reproduced in response to the button in the selected state. For example, a sound file is used to produce effect sound when the state of the button changes from the normal state to the selected state.

The fields selected_start_object_id_ref and selected_end_object_id_ref having a data length of 16 bits represent IDs which designate objects at the head and the tail of animations of the button in the selected state. Further, the next flag selected_repeat_flag having a data length of 1 bit represents whether or not the animation of the button should be repeated. For example, when the value of the flag selected_repeat_flag is “0”, it indicates that the animation of the button should not be repeated, but when it is “1”, it indicates that the animation of the button should be repeated.

The next flag selected_complete_flag has a data length of 1 bit. The next flag selected_complete_flag is for controlling the animation operation when the state of the button changes from the selected state to another state. In other words, the flag selected_complete_flag can be used for a case wherein the state of the button changes from the selected state to the activated state and another case wherein the state of the button changes from the selected state to the normal state.

Similarly, if the value of the flag selected_complete_flag is “1”, then when the state of the button changes from the selected state to another state, all animations defined to the selected state are displayed. More particularly, if the value of the flag selected_complete_flag is “1”, then if it is inputted to change the state of the button during animation display of the selected state of the button from the selected state to another state, then animation display is performed from the animation frame currently displayed at the point of time to the animation frame indicated by the field selected_end_object_id_ref described hereinabove.

Further, also when the value of the flag selected_complete_flag is “1” and besides the flag selected_repeat_flag indicates repeat (for example, has the value “1”), animation display is performed from the animation frame currently displayed at the point of time to the animation frame indicated by the field selected_end_object_id_ref described hereinabove.

In this instance, for example, even if a state wherein no button can be selected is entered or even if the display of buttons is erased, if the point of time at which such state change occurs is during display of animations, then animation display is performed up to an animation frame indicated by the field selected_end_object_id_ref, and thereafter, the button state is changed.

The state wherein no button can be selected may be entered, for example, when the above-described field selection_time_out_pts designates disabling of the buttons or when the menu is initialized automatically in accordance with the designation of the field user_time_out_duration.

On the other hand, if the value of the flag selected_complete_flag is “0”, then when the state of the button changes from the selected state to another state, the animation defined by the button in the selected state is not displayed up to an animation frame indicated by the field selected_end_object_id_ref, but the animation display is stopped at a point of time designated by the instruction of the change of the state and the button in the different state is displayed.

In the block activated_state_info( ), the field activated_state_sound_id_ref has a data length of 8 bits and represents a sound file to be reproduced in response to the button in the activated state. The fields activated_start_object_id_ref and activated_end_object_id_ref having a data length of 16 bits represent IDs which designate animation frames (that is, button images) at the head and the tail of the animations of the button in the activated state. If the fields activated_start_object_id_ref and activated_end object_id_ref refer to the same button image, then this indicates that only one button image is associated with the button in the activated state.

It is to be noted that the field activated_start_object_id_ref or activated_end_object_id_ref represents that no button image is designated when it has the value of [0xFFFF]. As an example, if the value of the field activated_start_object_id_ref is [0xFFFF] and besides the value of the field activated_end_object_id_ref indicates a valid button image, then it is determined that no button image is associated with the button in the activated state. However, it is otherwise possible to determine that the button is invalid if the value of the field activated_start_object_id_ref indicates a valid button image and besides the value of the field activated_end_object_id ref is [0xFFFF].

The description of the block activated_state_info( ) ends therewith. The next field number_of_navigation_commands has a data length of 16 bits and represents the number of commands embedded in the button. Then, a loop beginning with a next for statement is repeated by a number of times indicated by the field number_of navigation_commands, and the command navigation_command( ) activated by the button is defined. This signifies that a plurality of commands can be activated from one button.

Now, a decoder model of the interactive graphics (hereinafter referred to simply as IG) is described with reference to FIG. 20. It is to be noted that the configuration shown in FIG. 20 performs decoding of interactive graphics and can be used commonly also in decoding of presentation graphics.

First, if a disk is loaded into the player, then the index file “index.bdmv” and the movie object file “MovieObject.bdmv” are read in from the disk, and the top menu is displayed in a predetermined manner. If the user designates a title to be reproduced based on the display of the top menu, then a playlist file for reproducing the designated title is called in accordance with a corresponding navigation command in the movie object file. Then, a clip AV stream file whose reproduction is requested from the playlist, that is, an MPEG2 transport stream, is read out from the disk in accordance with the description of the playlist file.

The transport stream is supplied as TS packets to a PID filter 100, by which the PID is analyzed. The PID filter 100 classifies the TS packets supplied thereto to determine which one of video data, audio data, menu data and subtitles data each of the TS packets retains. If the PID represents menu data, that is, interactive graphics or alternatively, PID represents presentation graphics, then the configuration of FIG. 20 is enabled. It is to be noted that description of the presentation graphics is omitted herein because the presentation graphics have no direct relation to the present invention.

The PID filter 100 selects those TS packets in which data with which the decoder model is compatible are placed from within the transport stream and cumulatively stores the selected TS packets into a transport buffer (TB) 101. Then, the data placed in the payload of the TS packets are extracted on the transport buffer 101. After those data sufficient to construct a PES packet are accumulated into the TB 101, a PES packet is re-constructed based on the PID. In other words, at this stage, the segments divided in the TS packets are unified.

The PES packet of the segments is supplied in an elementary stream format with the PES header removed to a decoder 102 and stored once into a coded data buffer (CDB) 110. If any of the elementary streams stored in the CDB 110 indicates based on the STC that time indicated by the corresponding DTS comes, then the segments are read out from the CDB 110 and transferred to a stream graphics processor 111, by which it is decoded and developed into segments.

The stream graphics processor 111 stores those segments for which decoding is completed in a predetermined manner into a decoded object buffer (DB) 112 or a composition buffer (CB) 113. If any segment is of the type which has the DTS like the PCS, ICS, WDS or ODS, then the stream graphics processor 111 stores the segment into the DB 112 or the CB 113 at a timing indicated by the corresponding DTS. On the other hand, any segment of the type which does not have the DTS like the PDS is stored immediately into the CB 113.

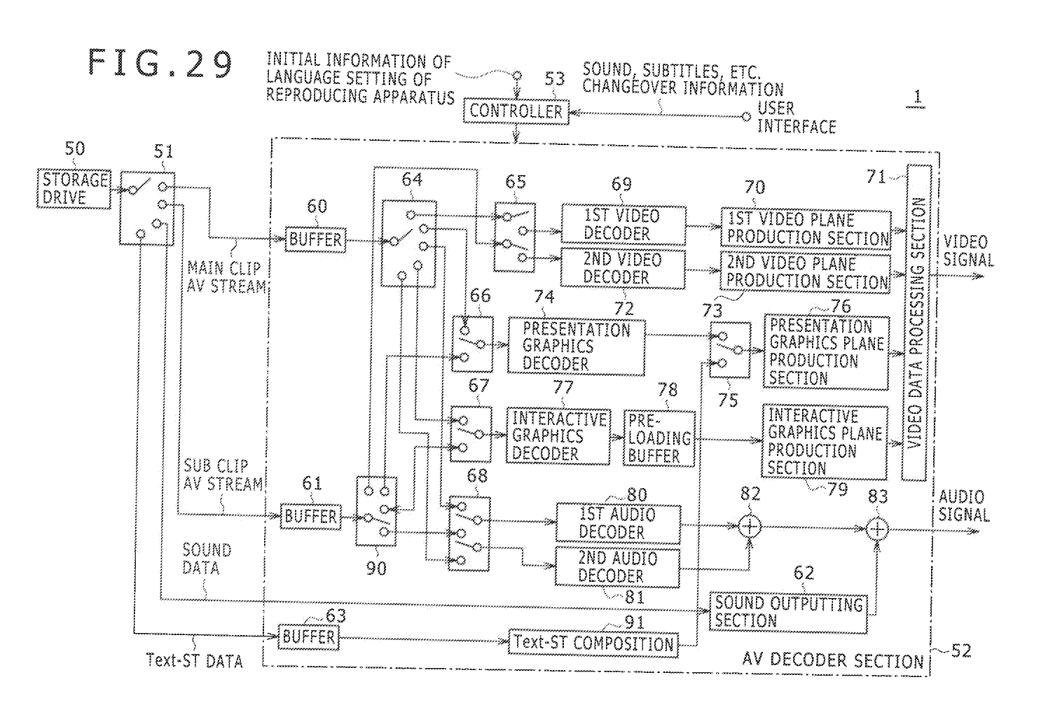

A graphics controller 114 controls the segment. The graphics controller 114 reads out the ICS from the composition buffer 113 at a timing indicated by the PTS corresponding to the ICS and reads out the PDS which is referred to by the ICS. Further, the graphics controller 114 reads out the ODS which is referred to from the ICS from the decoded object buffer 112. Then, the graphics controller 114 decodes the thus read out ICS and ODS to form data for displaying a menu screen image such as a button image and writes the formed data into a graphics plane 103. It is to be noted that the graphics controller 114 may be incorporated in the form of an LSI for exclusive use or the like or may be incorporated in the form of a general-purpose CPU or the like. As the physical configuration, the graphics controller 114 may be a controller same as or may be separate from a controller of a controller 53 shown in FIG. 29.

Further, the graphics controller 114 decodes the PDS read out from the composition buffer 113 to form, for example, such a color palette table as described hereinabove with reference to FIG. 11 and writes the formed color palette table into a CLUT 104.

The image written in the graphics plane 103 is read out at a predetermined timing, for example, at a frame timing, and the color palette table in the CLUT 104 is referred to and color information is added to the read out image to form output image data. The output image data are outputted.

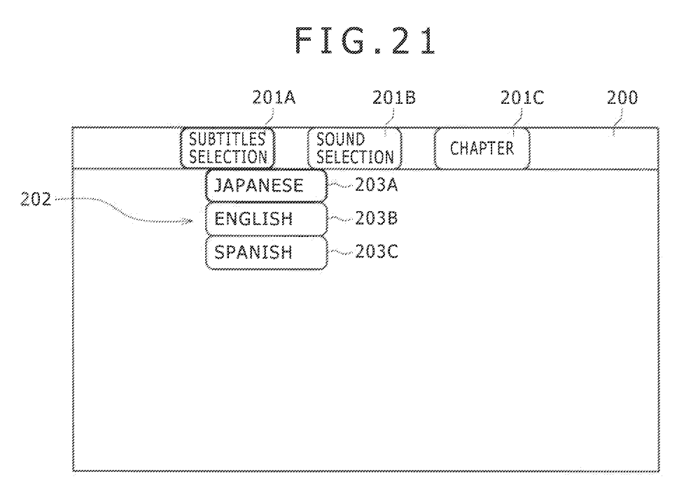

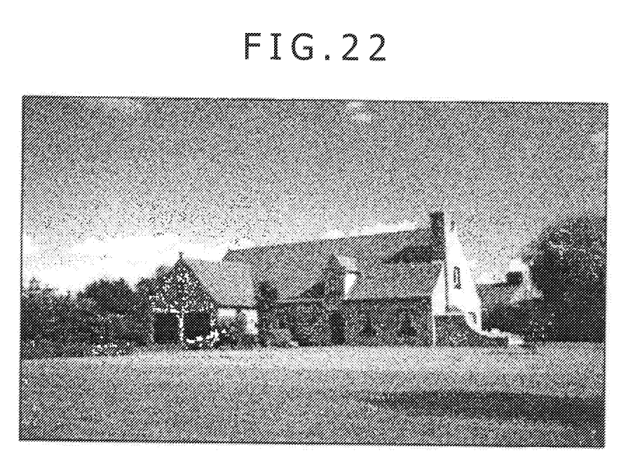

An example wherein a menu display image based on an IG stream and a video stream reproduced based on a playlist of the main path are synthesized and displayed is described generally with reference to FIGS. 21 to 23.

FIG. 21 shows an example of a menu display image displayed based on an IG stream. In the example shown in FIG. 21, a background 200 of the menu is displayed and buttons 201A, 201B and 201C are displayed based on an IG stream. Button images indicating the normal state, selected state and activated state are prepared for each of the buttons 201A, 201B and 201C. The background 200 of the menu is inhibited from movement and is displayed in response to a button (hereinafter referred to as special button) to which no command is set. It is to be noted that there is a restriction that the buttons cannot be displayed in an overlapping relationship with each other. Therefore, an independent special button is disposed at each of portions sandwiched by the buttons 201A, 201B and 201C, a portion on the left side of the button 201A and a portion on the right side of the button 201C.

For example, if an instruction for rightward movement or leftward movement is issued in response to an operation of the cross key on the remote control commander, then a button image in the normal state and a button image in the selected state are successively and switchably displayed in accordance with the instruction. Further, in the example of FIG. 21, for example, if an operation of the cross key to designate the downward direction is performed or an operation of the determination key is performed while a button is in a selected state, then a pull-down menu 202 corresponding to the button in the selected state is displayed.

The pull-down menu 202 is formed, for example, from a plurality of buttons 203A, 203B and 203C. Also for the buttons 203A, 203B and 203C, button images indicating the normal state, selected state and activated state can be prepared similarly to the buttons 201A, 201B and 201C described hereinabove. If upward or downward movement is designated, for example, by an operation of the cross key in a state wherein the pull-down menu 202 is displayed, then a button image in the normal state and a button image in the selected state are successively and switchably displayed in response to an operation of each of the buttons 203A, 203B and 203C of the pull-down menu 202. For example, in response to an operation of the determination key, the image to be displayed is switched from a button image in the selected state displayed to a button image in the activated state, and the button image in the activated state is displayed under display control by an embodiment of the present invention as hereinafter described. Thus, a function allocated to the button is executed by the player.

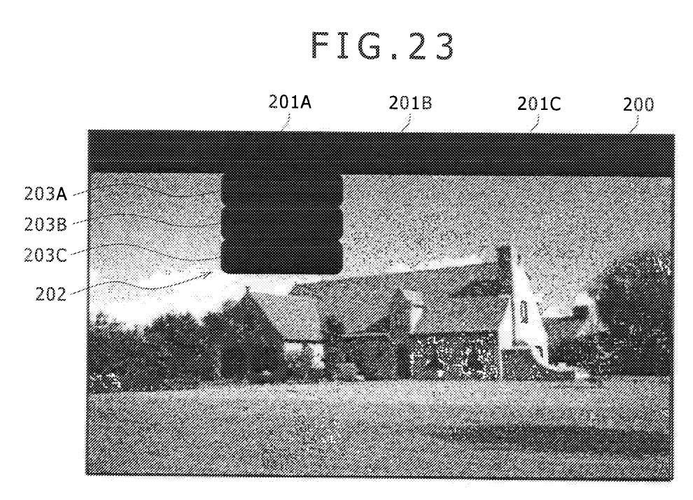

Synthesis of such a menu display image as described above and such moving picture data reproduced by the playitem of the main path and displayed on the moving picture plane 10 as seen from FIG. 22 is studied. In the screen image of FIG. 21, the opacity α at portions other than the menu display including the region of the pull-down menu 202 is set to “0”, and the interactive graphics plane 12 and the moving picture plane 10 are synthesized. Consequently, a display image wherein the menu display illustrated in FIG. 21 is synthesized with the moving picture data illustrated in FIG. 22 is obtained as seen in FIG. 23.

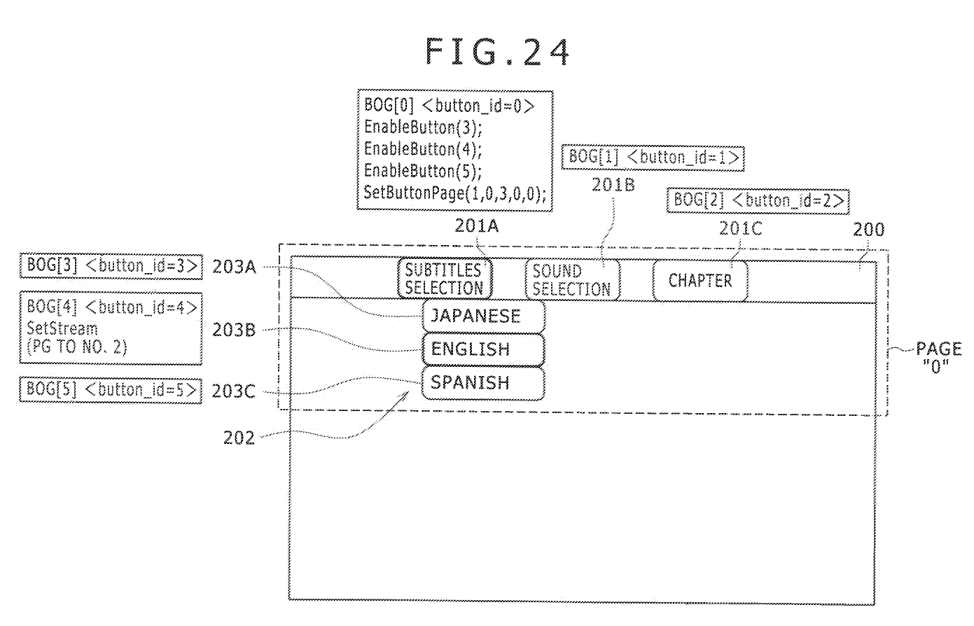

Now, an example of a method for implementing pull-down menu display in the menu display described above is described generally. In particular, an example wherein the determination key of the remote control commander is operated to display the pull-down menu 202 while the button 201A is in the selected state is described with reference to FIG. 24. It is to be noted that, the common components between the components in FIG. 24 and FIG. 21 have the same reference symbols, thereby omitting detailed explanation.

In the example of FIG. 24, a menu display image including a background 200, buttons 201A, 201B and 201C and a pull-down menu 202 is displayed on a menu screen image indicated by a page “0”. The buttons 201A, 201B and 201C are a button overlap group (BOG) whose value button_id applied for identification of the buttons is defined by “1”, “2” and “3”, respectively. Further, the buttons 203A, 203B and 203C in the pull-down menu 202 corresponding to the button 201A are a button overlap group whose value button_id is “3”, “4” and “5”, respectively.

If the button 201A is taken as an example, then, in a portion of the command navigation_command( ) executed by the button 201A in the block button( ) which defines the button 201A, commands are described, for example, as given below:

### EnableButton(3);

### EnableButton(4);

### EnableButton(5);

### SetButtonPage(1,0,3,0,0).

In the commands above, the command Enablebutton( ) indicates to place a button, for which the value indicated in the parentheses “( )” is defined as the value button_id, into an enabled state or valid state. The command SetButtonPage( ) is used, for example, to make the button, which is placed into an enabled state by the command EnableButton( ), selectable. The command SetButtonPage has five parameters button_flag, page_flag, button_id, page_id and out_effect_off_flag. The parameter button_flag indicates to set the value of the third parameter button_id to a memory (PSR: Player Status Register) for managing the reproduction state which the player has. The parameter page_flag indicates whether or not the value page_id for identifying a page retained in the PSR should be changed to the fourth parameter page_id. Further, the parameter out_effect_off_flag indicates whether or not an effect defined for the button 201A should be executed when the button 201A is placed into a non-selected state.

Also for each of the buttons 203A, 203B and 203C which form the pull-down menu 202, the command navigation_command( ) which is executed when the button is placed into a determined state is described. In the example of FIG. 24, the command SetStream( ) for setting a stream to be used is described for the button 203B. In this example, it is indicated by the command SetStream( ) that the second PG stream is to be used.

It is to be noted that such a command navigation_command( ) described for each button as described above is a mere example, and the command to be described for each button is not limited to this. For example, the command SetStream( ) may be described also for the buttons 203A and 203C of the pull-down menu 202 for selecting subtitles similarly for the button 203B described above.

In the menu screen image shown in FIG. 24, if the determination key is depressed when the button 201A is in the selected state, then the buttons whose value button_id is defined by “3”, “4” and “5”, that is, the buttons 203A, 203B and 203C of the pull-down menu 202, are placed into a valid state, and a corresponding button image is displayed. At this time, the button 203A indicated by the value button_id of “3” is placed into the selected state based on the description of the command SetButtonPage(1,0,3,0,0).

Further, if a downward direction is designated by an operation of the cross key or the like, then a focus for a button is moved downwardly to place the button 203A from the selected state into the normal state and place the button 203B from the normal state into the selected state. If the determination key is operated in this state, then the second PG stream is selected in accordance with the description of the command navigation_command( ) for the button 203B. Consequently, the subtitles display is changed over to subtitles of the English language.

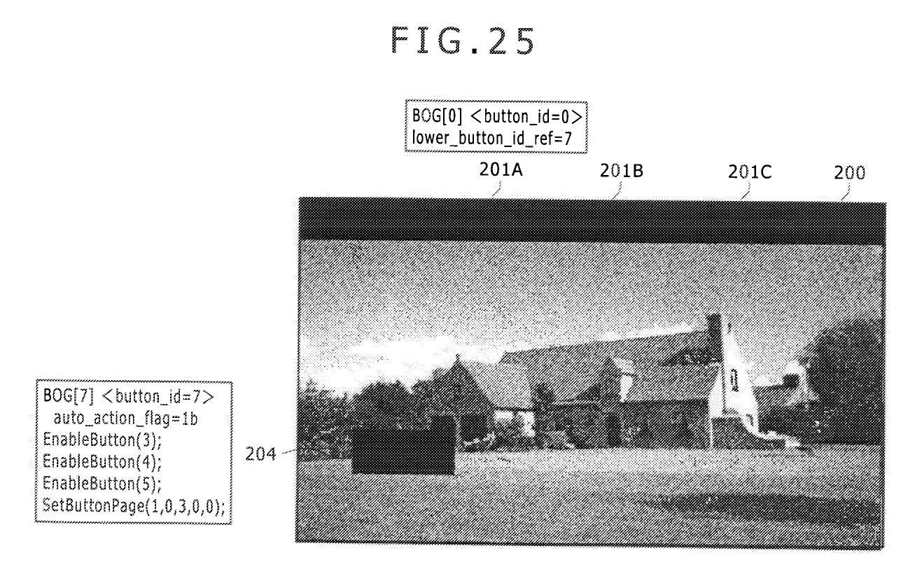

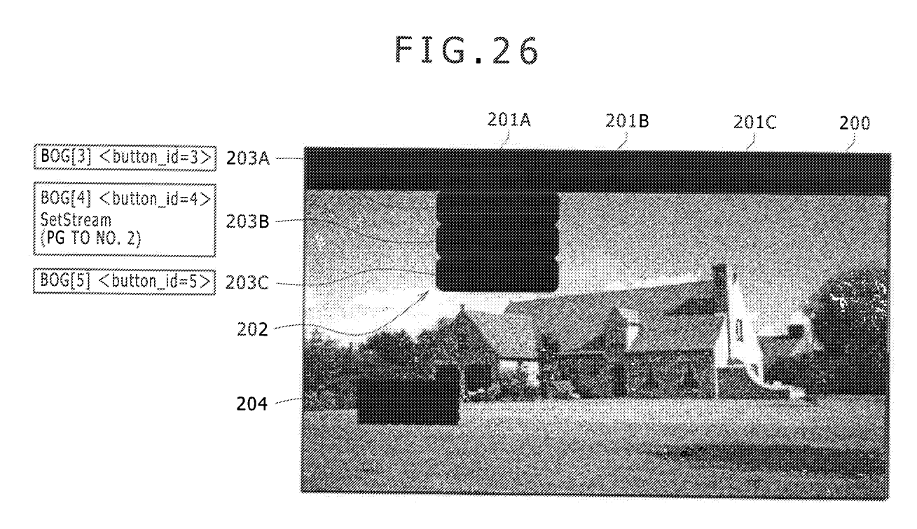

As another example, an example wherein, while the button 201A is in the selected state, an operation to designate a downward direction is performed using the cross key of the remote control commander or the like to display the pull-down menu 202 is described with reference to FIGS. 25 and 26. In FIGS. 25 and 26, moving picture data displayed on the moving picture plane 10 based on the playitem of the main path are synthesized with the menu display screen.

It is to be noted that, the common components between the components in FIGS. 26 and 25 and the components in FIGS. 21, 23 and 24 have the same reference symbols, thereby omitting detailed explanation. For example, the buttons 203A, 203B and 203C on the pull-down menu 202 shown in FIG. 26 are defined by “3”, “4” and “5” of the value button_id, respectively, and the command SetStream( ) which designates use of the second PG stream is described for the button 203B.

Where it is intended to display the pull-down menu 202 using not the determination key but a downward key in response to the selected state of a button, it is a possible method to use a hidden button 204 which is provided so as not to be visually observed by the user, for example, as illustrated in FIGS. 25 and 26. The hidden button 204 can be implemented, for example, by designating the opacity α=0 to button image data associated with the hidden button 204. While, in FIGS. 25 and 26, the hidden button 204 is shown as a framework of a broken line for the convenience of illustration, actually the hidden button 204 is not displayed but an image of the rear plane (for example, the moving picture plane 10) is displayed through the hidden button 204.

Referring to FIG. 25, in the block button( ) for defining the hidden button 204, the value button_id for identifying the hidden button 204 is set, for example, to “7”, and the hidden button 204 is set as a button overlap group defined by “7” of the value button_id. Further, in the block button( ), the value of the flag auto_action_flag is set, for example, to “1b” (“b” indicates that the preceding numerical value is a binary value), and this hidden button 204 is defined so as to automatically change its state from the selected state to the activated state. Then, for example, such commands as given below are described in a portion of the command navigation_command( ) executed in response to the hidden button 204:

### EnableButton(3);

### Enablebutton(4);

### EnableButton(5);

### SetButtonPage(1,0,3,0,0).

Meanwhile, for example, for the button 201A for performing subtitles selection, the value of the field lower_button_id_ref is set to “7” such that, if a downward direction is designated by an operation of the cross key or the like while the button 201A is in the selected state, then the button whose value button_id is “7”, that is, the hidden button 204 in this instance, is placed into the selected state.

If, on the menu screen image illustrated in FIG. 25, while the button 201A is in a selected state, a downward direction is designated by an operation of the cross key or the like, then the hidden button 204 whose value button_id is “7” is placed into a selected state in accordance with the description of the field lower_button_id_ref for the button 201A. Here, the hidden button 204 is defined by the flag auto_action_flag such that the state thereof changes automatically from the selected state to the activated state. Therefore, the buttons whose value button_id is defined by “3”, “4” and “5”, that is, the buttons 203A, 203B and 203C of the pull-down menu 202, are placed into a valid state in accordance with the description of the command EnableButton( ) at a portion of the command navigation_command( ) for the hidden button 204, and a corresponding button image is displayed (refer to FIG. 26). At this time, the button 203A whose value button_id is indicated by “3” is placed into the selected state based on the description of the command SetButtonPage(1,0,3,0,0).

Further, if a downward direction is designated by an operation of the cross key or the like, then the focus for a button is moved to change the button 203A from the selected state to the normal state and change the button 203B from the normal state to the selected state. If the determination button is operated in this state, then the second presentation graphics stream is selected in accordance with the description of the command navigation_command( ) for the button 203B, and the subtitles display image is changed over to a subtitles display image of the English language.

Now, a preferred embodiment of the present invention is described. As described hereinabove with reference to FIG. 19, a button image and sound data can be associated with a button in an activated state. The present invention provides a display control method for a button image indicating an activated state where only one button image indicating an activated state is associated with a button in an activated state while any other object is not associated with the button.

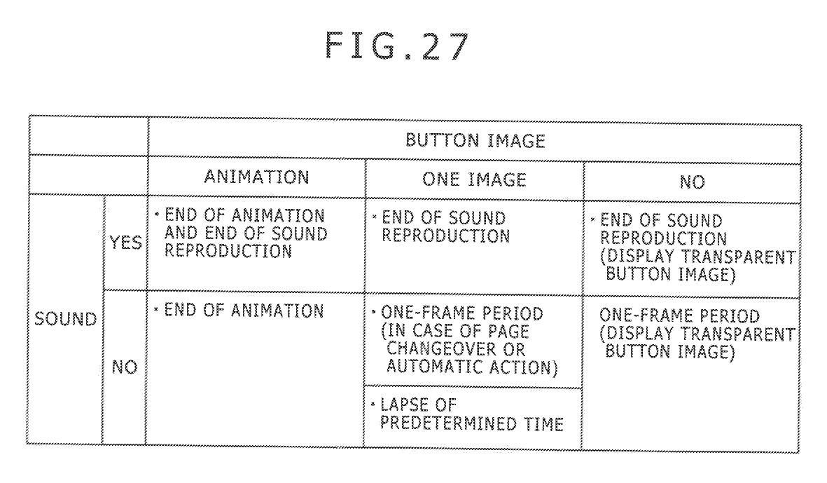

FIG. 27 illustrates examples of display control when a button is placed into an activated state according to the embodiment of the present invention wherein the examples are classified depending upon the object associated with the activated state of the button. After a button is placed into an activated state, display is performed based on one of the controls illustrated in FIG. 27, whereafter a navigation command is executed.

Where a plurality of button images, that is, a plurality of animations, are associated with an activated state of a button and besides sound data are associated with the activated state of the button, the navigation command is executed after reproduction of the sound data comes to an end. Where a plurality of animations are associated with the activated state of the button but sound data are not associated with the activated state of the button, the navigation command is executed after display of the animations comes to an end.

Where only one button image is associated with the activated state of the button and besides sound data are associated with the activated state of the button and besides sound data are associated with the activated state of the button, the navigation command is executed after reproduction of the sound data comes to an end.

Where only one button image is associated with the activated state of the button but sound data are not associated with the activated state of the button, display control unique to the embodiment of the present invention is performed. In this instance, a different process is executed based on the substance of the navigation command defined for the button and the value of the flag auto_action_flag defined for the button.

In particular, where the navigation command defined for the button involves changeover of the page of the menu display or where the flag auto_action_flag defined for the button indicates that the button is an automatic action button to which a function which is automatically executed when the button is placed into the selected state is allocated, the button image in the activated state is displayed for a period of time of one frame, whereafter the navigation command is executed. It is to be noted that any button defined as an automatic action button by the flag auto_action_flag is considered to automatically enter an activated state when it is placed into the selected state.

Meanwhile, in a case wherein only one button image is associated with the activated state of the button and sound data are associated with the activated state of the button and besides the navigation command defined for the button does not involve page changeover of the menu display and the button is not defined as an automatic action button, the button image in the activated state is kept displayed for a predetermined period of time within which it can be presented explicitly that the button is in the activated state. Thereafter, the navigation command is executed.

As an example, by setting the predetermined period of time to approximately 500 milliseconds, it is indicated explicitly to the user that the button is in the activated state and a flow of operation by the user is not disturbed. Naturally, the predetermined period of time is not limited to 500 milliseconds, but any other period of time may be used only if the initial object that it is indicated explicitly to the user that the button is in the activated state and a flow of operation by the user is not disturbed can be achieved. In other words, that the button is in the activated state is indicated explicitly to the user at least for a period of time longer than one frame (for two or more frames).

Where the button image is not associated with the activated state of the button, a transparent button image is displayed. Where sound data is associated with the button, the navigation command is executed after reproduction of the sound data ends. Where none of a button image and sound data are associated with the button in the activated state, a transparent button image is displayed for a period of time of one frame, whereafter the navigation command is executed. It is to be noted that the transparent button image can be implemented by setting the opacity α for the button image to α=0.

In this manner, according to the embodiment of the present invention, where only one button image is associated with the activated state of a button but sound data are not associated with the activated state of the button and besides the navigation command defined for the button does not involve page changeover of the menu display and the button is not defined as an automatic action button, one button image associated with the activated state of the button is kept displayed for a predetermined period of time within which it can be presented explicitly that the button is in the activated state. Therefore, the user can easily recognize that the button is in the activated state.

In particular, according to the embodiment of the present invention, even where only one button image is associated with the activated state of a button but sound data are not associated with the activated state of the button and besides the navigation command defined for the button does not involve page changeover of the menu display and the button is not defined as an automatic action button, the activated state of the button is displayed appropriately.

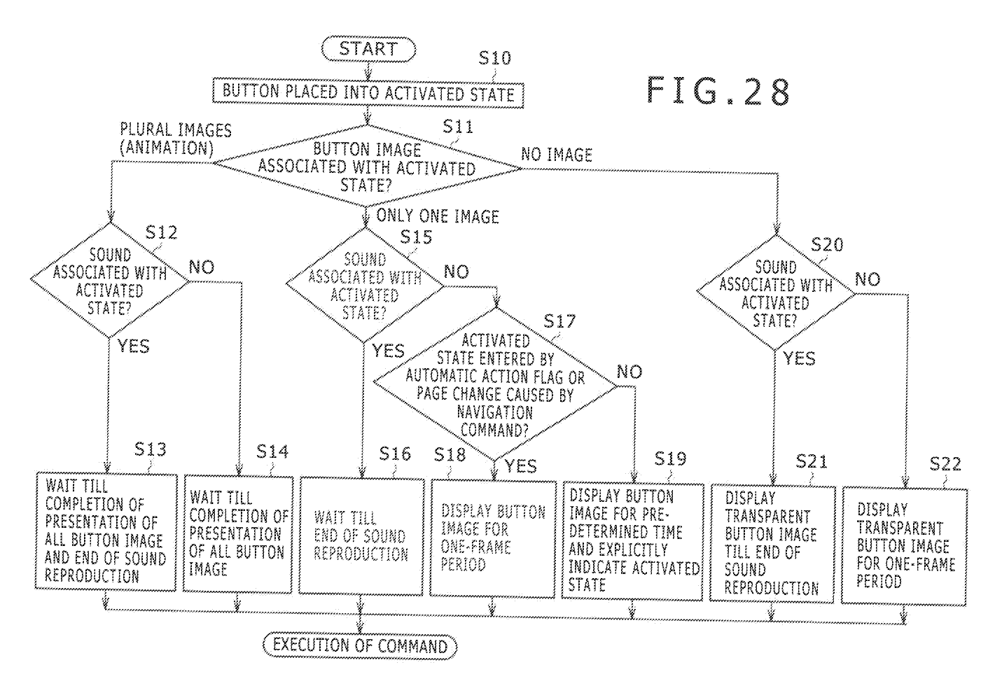

FIG. 28 is a flow chart illustrating an example of a method of performing such display control of a button according to the embodiment of the present invention as described above. The procedure of the flow chart of FIG. 28 is executed, in the decoder model of interactive graphics described hereinabove with reference to FIG. 20, under the control of the graphics controller 114 based on the syntaxes accumulated in the composition buffer 113.

If a certain button is placed into an activated state on the menu display image (step S10), then a button image associated with the activated state of the button is checked at step S11. The processing is branched at step S11 depending upon whether a plurality of button images are associated with the activated state of the button or only one image is associated or else no button image is associated.

For example, the block button( ) is referred to in the decoded ICS stored in the CB 113 (refer to FIG. 19), and the block activated_state_info( ) in the block button( ) is detected, and then the values of the fields activated_start_object_id_ref and activated_end_object_id_ref are acquired. Based on the values of the fields activated_start_object_id_ref and activated_end_object_id_ref, it can be decided whether a plurality of button images are associated with the activated state of the button or only one button image is associated or else no button image is associated.

In particular, if the values of the fields activated_start_object_id_ref and activated_end_object_id_ref coincide with each other, then it is decided that only one button image is associated with the activated state of the button. If the field activated_start_object_id_ref indicates a vaid_button image and the field activated_end_object_id_ref has the value [0xFFFF], then it may be decided that only one button image is associated with the activated state of the button. On the other hand, if the field activated_start_object_id_ref has the value [0xFFFF] and the field activated_end_object_id_ref indicates a vaid_button image, then it can be decided that no button image is associated with the activated state of the button. Furthermore, if the fields activated_start_object_id_ref and activated_end_object_id_ref indicate valid button images different from each other, then it can be decided that a plurality of button images are associated with the activated state of the button.

It is to be noted that, while details are hereinafter described, a navigation command associated with the button is read in at the stage of step S10 described hereinabove.

If it is decided at step S11 that a plurality of button images are associated with the activated state of the button, then the processing advances to step S12, at which it is decided whether or not sound data are further associated with the activated state of the button. For example, the block button( ) is referred to in the decoded ICS stored in the CB 113, and the block activate_state_info( ) in the block button( ) is searched and then the value of the field activated_state_sound_id_ref is acquired. Based on the value of the field activated_state_sound_id_ref, it can be decided whether or not sound data are associated with the activated state of the button.

If it is decided that sound data are further associated with the activated state of the button, then the processing advances to step S13. At step S13, animation display based on the button images associated with the activated state of the button is performed and the sound data are reproduced. Then, after it is waited that the animation display and the reproduction of the sound data come to an end, the navigation command associated with the button is executed.

As an example, the graphics controller 114 reads out the decoded PDS referred to from the decoded ICS stored in the CB 113 from the CB 113 and reads out the corresponding decoded ODS from the decoded object buffer 112 to form data for displaying a button image. Then, the graphics controller 114 performs predetermined display control based on animation setting described in the block page( ) of the ICS to write the button image data into the graphics plane 103 to perform animation display. Further, the graphics controller 114 communicates with a sound controller (not shown) which controls reproduction sound data to detect an end of the reproduction of the sound data. Also it is possible to control the graphics controller 114 and the sound controller to decide an end of the animation control and the sound data reproduction based on a control signal from a higher order controller of the like.

On the other hand, if it is decided at step S12 that no sound data is associated with the activated state of the button, then the processing advances to step S14. At step S14, animation display based on the button images associated with the activated state of the button is performed. After it is waited that the animation display comes to an end, the navigation command associated with the button is executed.

If it is decided at step S11 that one button image is associated with the activated state of the button, then the processing advances to step S15, at which it is decided whether or not sound data are further associated with the activated state of the button. If it is decided that sound data are further associated, then the processing advances to step S16, at which the sound data are reproduced. Then, after it is waited that the reproduction of the sound data comes to an end, the navigation command associated with the button is executed.

On the other hand, if it is decided at step S15 that one button image is associated with the activated state of the button and sound data are not associated with the activated state of the button, then the processing advances to step S17. At step S17, it is decided whether the navigation command defined for the button is defined as a command wherein the button is defined as an automatic action button or as a command which involves changeover of the page of the menu display.

Whether or not the button is defined as an automatic action button is performed by referring to the flag auto_action_flag in the block button( ) of the button illustrated in FIG. 19.

Further, whether or not the button is associated with a command which involves changeover of the page of the menu display can be performed by reading in, in advance, the navigation command (command navigation_command( )) described rearwardly of the block activated_state_info( ) which defines the activated state of the button, on the terminal end side in the block button( ) of the button illustrated in FIG. 19. In this example, as described hereinabove, the navigation command is read in in advance at the stage of step S10. The navigation command may be read in by the graphics controller 114, or may be read in by the higher order controller of the graphics controller 114 and transferred to the graphics controller 114.

If it is decided at step S17 that either the button is defined as an automatic action button or the navigation command defined for the button involves changeover of the page of the menu display, then the processing advances to step S18. At step S18, a button image in the activated state is displayed for a period of time of one frame, and then the navigation command is executed.

On the other hand, if it is decided at step S17 that the button is defined as an automatic action button or the navigation command defined for the button involves changeover of the page of the menu display, then the processing advances to step S19. At step S19, one button image associated with the button is displayed for a predetermined period of time (for example, 500 milliseconds) so that the button image is presented explicitly to the user. Thereafter, the navigation command is executed.

If it is decided at step S11 that no button image is associated with the activated state of the button, then the processing advances to step S20, at which it is decided whether or not sound data are further associated with the activated state of the button. If it is decided that sound data are further associated, then the processing advances to step S21, at which a transparent button image is displayed and the sound data are reproduced. Then, after it is waited that the reproduction of the sound data comes to an end, the navigation command associated with the button is executed.

On the other hand, if it is decided at step S20 that no sound data are associated with the activated state of the button, then the processing advances to step S22. At step S22, a transparent button image is displayed for a period of time of one frame, and then the navigation command associated with the button is executed.

Now, a reproduction apparatus which can be applied to the embodiment of the present invention is described. FIG. 29 shows an example of a configuration of a reproduction apparatus 1 which can be applied to the embodiment of the present invention. Referring to FIG. 29, the reproduction apparatus 1 shown includes a storage drive 50, a switch circuit 51, an AV decoder section 52 and a controller section 53. The storage drive 50 can reproduce, for example, a BD-ROM described herein above which is loaded therein.

The controller section 53 includes, for example, a CPU (Central Processing Unit), a ROM (Read Only Memory) in which programs which operate on the CPU are stored in advance, a RAM (Random Access Memory) used as a working memory upon execution of a program by the CPU, and so forth. The controller section 53 controls general operation of the reproduction apparatus 1.

Though not shown in FIG. 29, the reproduction apparatus 1 includes a user interface which provides predetermine control information to the user and outputs a control signal in response to an operation of the user. A remote control commander which remotely communicates with the reproduction apparatus 1 through predetermined radio communication means such as, for example, infrared communication is used as the user interface. A plurality of inputting elements such as a direction key or keys such as a cross key which can designate upward, downward, leftward and rightward directions, numerical keys and function keys to which various functions are allocated in advance are provided on the remote control commander. It is to be noted that the cross key may have any shape only if upward, downward, leftward and rightward directions can be designated individually thereby.

The remote control commander produces a control signal in response to an operation performed for any of the inputting elements and modulates and transmits the produced control signal, for example, into and as an infrared signal. The reproduction apparatus 1 receives the infrared signal by means of an infrared reception section thereof not shown, converts the infrared signal into an electric signal and demodulates the electric signal to restore the original control signal. The control signal is supplied to the controller section 53. The controller section 53 controls operation of the reproduction apparatus 1 in response to the control signal in accordance with the program.

The user interface is not limited to the remote controller commander but may be formed, for example, from switches provided on an operation panel of the reproduction apparatus 1. Further, the reproduction apparatus 1 may include a communication section for performing communication through a LAN (Local Area Network) or the like such that a signal supplied from an external computer apparatus through the communication section is supplied as a control signal by the user interface to the controller section 53.

Further, initial information of language setting of the reproduction apparatus 1 is stored in a nonvolatile memory provided in the reproduction apparatus 1. The initial information of the language setting is read out from the memory, for example, when power supply to the reproduction apparatus 1 is made available and is supplied to the controller section 53.

If a disk is loaded into the storage drive 50, then the controller section 53 reads out the file index.bdmv and the file MovieObject.bdmv on the disk through the storage drive 50 and reads out playlist files in the directory “PLAYLIST” based on the description of the read out file. The controller section 53 reads out a clip AV stream referred to by playitems included in the playlist file from the disk through the storage drive 50. Further, if the playlist includes a sub playitem, then the controller section 53 reads out also a clip AV stream and sub title data referred to by the sub playitem from the disk through the storage drive 50.

It is to be noted that, in the following description, a clip AV stream corresponding to a sub playitem is referred to as sub clip AV stream, and a clip AV stream corresponding to a principal playitem with respect to the sub playitem is referred to as main clip AV stream.

The data outputted from the storage drive 50 are subjected to a predetermined decoding process and a predetermined error correction process by a demodulation section and an error correction section not shown, respectively, to restore a multiplexed stream. The multiplexed stream here is a transport stream wherein data divided in a predetermined size are time division multiplexed based on the type and the arrangement order thereof identified based on the PID. The multiplexed stream is supplied to the switch circuit 51. The controller section 53 controls the switch circuit 51 in a predetermined manner, for example, based on the PID to classify the data for the individual types and supplies packets of the main clip AV stream to a buffer 60. Meanwhile, packets of the sub clip AV stream are supplied to another buffer 61 and packets of sound data are supplied to a sound outputting section 62 while packets of text data are supplied to a further buffer 63.

Packets of the main clip AV stream accumulated in the buffer 60 are read out one after another from the buffer 60 under the control of the controller section 53 and supplied to a PID filter 64. The PID filter 64 distributes the packets based on the PID thereof among packets of a video stream, packets of a presentation graphics stream (hereinafter referred to as PG stream), packets of an interactive graphics stream (hereinafter referred to as IG stream) and packets of an audio stream.

On the other hand, packets of the sub clip AV stream accumulated in the buffer 61 are read out one after another from the buffer 61 under the control of the controller section 53 and supplied to a PID filter 90. The PID filter 90 distributes the packets based on the PID thereof among packets of a video stream, packets of a PG stream, packets of an IG stream and packets of an audio stream.

The packets of a video stream distributed by the PID filter 64 and the packets of a video stream distributed by the PID filter 90 are supplied to a PID filter 65, by which they are distributed in response to the PID. In particular, the PID filter 65 distributes the packets such that the packets of the main clip AV stream supplied from the PID filter 64 are supplied to a first video decoder 69 and the packets of the sub clip AV stream supplied from the PID filter 90 are supplied to a second video decoder 72.

The first video decoder 69 extracts a video stream from the payload of the packets supplied thereto and decodes thus extracted compression codes of the MPEG2 system. An output of the first video decoder 69 is supplied to a first video plane production section 70, by which a video plane is produced. The video plane is produced, for example, by writing one frame of digital video data of a baseband into a frame memory. The video plane produced by the first video plane production section 70 is supplied to a video data processing section 71.

The second video decoder 72 and a second video plane production section 73 perform processes similar to those of the first video decoder 69 and the first video plane production section 70 described hereinabove, respectively, to decode the video stream to produce a video plane. The video plane produced by the second video plane production section 73 is supplied to the video data processing section 71.

The video data processing section 71 can, for example, fit the video plane produced by the first video plane production section 70 and the video plane produced by the second video plane production section 73 in a predetermined manner into one frame to produce one video plane. Alternatively, the video plane produced by the first video plane production section 70 and the video plane produced by the second video plane production section 73 may be selectively used to produce a video plane. The video plane corresponds, for example, to the moving picture plane 10 described hereinabove with reference to FIG. 9.

The packets of a PG stream distributed by the PID filter 64 and the packets of a PG stream distributed by the PID filter 90 are supplied to a switch circuit 66, by which the packets from one of the PID filter 64 and the PID filter 90 are selected. The selected packets are supplied to a presentation graphics decoder 74. The presentation graphics decoder 74 extracts a PG stream from the payload of the packets supplied thereto in a predetermined manner and decodes the PG stream to produce graphics data for displaying subtitles. The produced graphics data are supplied to a switch circuit 75.

The switch circuit 75 selects the graphics data and subtitles data of text data hereinafter described in accordance with a predetermined manner and supplies the selected data to a presentation graphics plane production section 76. The presentation graphics plane production section 76 produces a presentation graphics plane based on the data supplied thereto and supplies the presentation graphics plane to the video data processing section 71. The presentation graphics plane corresponds, for example, to the subtitles plane 11 described hereinabove with reference to FIG. 9.

The packets of an IG stream distributed by the PID filter 64 and the packets of an IG stream distributed by the PID filter 90 are supplied to a switch circuit 67, by which the packets from one of the PID filter 64 and the PID filter 90 are selected. The selected packets are supplied to an interactive graphics decoder 77. The interactive graphics decoder 77 extracts the ICS, PDS and ODS of the IG stream in a predetermined manner from the packets of the IG stream supplied thereto and decodes them. For example, the interactive graphics decoder 77 extracts data from the payload of the packets supplied thereto and re-construct a PES packet. Then, the interactive graphics decoder 77 extracts the ICS, PDS and ODS of the IG stream based on the header information of the PES packet and so forth. The decoded ICS and PDS are stored into a buffer called CB (Composition Buffer). Meanwhile, the ODS is stored into another buffer called DB (Decoded Buffer). For example, a preload buffer 78 shown in FIG. 29 corresponds to the CB and the DB.

It is to be noted that the PES packet has a PTS (Presentation Time Stamp), which is time management information relating to a reproduction output, and a DTS (Decoding Time Stamp), which is time management information relating to decoding. A menu according to the IG stream is displayed while the time thereof is managed based on the PTS placed in the corresponding PES packet. For example, data which are stored in the preload buffer described hereinabove and form the IG stream are read out at a predetermined timing based on the PTS.

The data of the IG stream read out from the preload buffer 78 are supplied to an interactive graphics plane production section 79, by which an interactive graphics plane is produced. The interactive graphics plane corresponds, for example, to the interactive graphics plane 12 described hereinabove with reference to FIG. 9.

For example, when the state of the button displayed changes from the selected state to the activated state in response to a predetermined operation for the inputting section provided for the user interface, the interactive graphics decoder 77 performs the process described hereinabove with reference to FIGS. 27 and 38 according to the embodiment of the present invention to perform display control of a button image associated with the activated state of the button based on the button image and the sound data associated with the activated state of the button.

For example, it is decided, based on the fields activated_start_object_id_ref and activated_end_object_id_ref in the block button( ) in the ICS described hereinabove, whether a plurality of button images are associated with the activated state of the button, whether one button image is associated or whether no button image is associated. Further, it is decided whether or not the navigation command associated with the button is read in in advance and involves a process of changing over the page of the menu display. Based on the decision results, it is decided whether or not the button image associated with the activated state of the button should be displayed as animation display, should be displayed only for a period of time of one frame or should be displayed for a predetermined period of time (for example, 500 milliseconds) within which the activated state of the button can be presented explicitly.

The video data processing section 71 includes the graphics processing section described hereinabove, for example, with reference to FIG. 10 and synthesizes the video plane (moving picture plane 10 shown in FIG. 10), presentation graphics plane (subtitles plane 11 shown in FIG. 10) and interactive graphics plane (interactive graphics plane 12 shown in FIG. 10) supplied thereto in a predetermined manner to produce single image data. Then, the video data processing section 71 outputs the image data in the form of a video signal.

The audio stream distributed by the PID filter 64 and the audio stream distributed by the PID filter 90 are supplied to a switch circuit 68. The switch circuit 68 selects the two audio streams supplied thereto such that one of the audio streams is supplied to a first audio decoder 80 while the other audio stream is supplied to a second audio decoder 81. The first audio decoder 80 and the second audio decoder 81 decode the audio streams, and the thus decoded streams are synthesized by an adder 82.

The sound outputting section 62 has a buffer memory and accumulates sound data supplied thereto from the switch circuit 51 into the buffer memory. Then, the sound outputting section 62 decodes the sound data accumulated in the buffer memory, for example, in accordance with an instruction from the interactive graphics decoder 77 and outputs the decoded sound data. The sound data outputted from the sound outputting section 62 are supplied to an adder 83, by which they are synthesized with the audio stream outputted from the adder 82. The reproduction end time of the sound data is conveyed, for example, from the sound outputting section 62 to the interactive graphics decoder 77. It is to be noted that cooperative control of the reproduction of sound data and the display of a button image may be performed in accordance with a command of the controller section 53 of a higher order.

Text data read out from the buffer 63 are processed in a predetermined manner by a Text-ST composition section and then supplied to the switch circuit 75.

While, in the foregoing description, the components of the reproduction apparatus 1 are formed from hardware, the configuration of the reproduction apparatus 1 is not limited to this. For example, it is possible to implement the reproduction apparatus 1 as processing on software. In this instance, it is possible to cause the reproduction apparatus 1 to operate on a computer apparatus. Also it is possible to implement the reproduction apparatus 1 as a mixed configuration of hardware and software. For example, it is a possible idea to configure those components of the reproduction apparatus 1 to which a comparatively high processing load is applied such as the decoders of the reproduction apparatus 1, particularly the first video decoder 69 and the second video decoder 72, from hardware and configure the other components from software.

Where the reproduction apparatus 1 is formed only from software or from mixture of hardware and software, a program to be executed by the computer apparatus is recorded in or on and provided together with a recording medium such as, for example, a CD-ROM (Compact Disc-Read Only Memory) or a DVD-ROM (Digital Versatile Disc Read Only Memory). The recording medium is loaded into a drive of the computer apparatus to install the program recorded in or on the recording medium in a predetermined manner into the computer apparatus to establish a state wherein the processing described hereinabove can be executed on the computer apparatus. Also it is a possible idea to record the program on a BD-ROM. It is to be noted that description of the configuration of the computer apparatus is omitted herein because it is well known in the art.

While a preferred embodiment of the present invention has been described using specific terms, such description is for illustrative purpose only, and it is to be understood that changes and variations may be made without departing from the spirit or scope of the following claims.

What is claimed is:

1. A reproduction apparatus for reproducing content data, comprising:
an inputting section to which content data, a plurality of button images individually associated with three states including a normal state, a selected state and an activated state for displaying a button by which the three stages can be defined and which is used in an operation screen image for urging a user to perform operation, and button control information including display control information for controlling display of the plural button images and a command to be executed in response to the activated state are inputted;
an operation inputting section configured to accept a user operation; and
a control section configured to perform display control of the normal state, selected state and activated state of the button by the button images based on the display control information and perform execution control of the command in response to the user operation for said operation inputting section;
said control section being operable to decide, when only one of the button images is associated with the activated state of the button, based on the display control information whether or not the display of the one button image should be performed for a predetermined period of time within which the activated state of the button can be presented explicitly and then execute the command after the display of the button image associated with the activated state of the button comes to an end.

2. The reproduction apparatus according to claim 1, wherein said control section decides that the display of the one button image associated with the activated state of the button should not be performed for the predetermined period of time if the display control information designates to automatically change the state of the button from the selected state to the activated state.

3. The reproduction apparatus according to claim 1, wherein the operation screen image can be constructed using a plurality of pages, and
said control section decides based on the display control information that the display of the one button image associated with the activated state of the button should not be performed for the predetermined period of time if the command executed in response to the activated state of the button with which only the one button image is associated involves changeover between the pages of the operation screen image.

4. The reproduction apparatus according to claim 1, wherein said control section controls based on the display control information so as to display the one button image only for a period of time of one frame if said control section decides, where only one of the button images is associated with the activated state of the button, that the display of the one button image should not be performed for the predetermined period of time within which the activated state of the button can be presented explicitly.

5. The reproduction apparatus according to claim 1, wherein, where sound data associated with the button are inputted to said inputting section, if the sound data and the one button image are associated with the activated state of the button, then said control section executes the command after reproduction of the sound data comes to an end.

6. A display controlling method, comprising the steps of:
performing, in response to a user operation for an operation inputting section which accepts a user operation, based on display control information for controlling display of a plurality of button images associated with three states including a normal state, a selected state and an activated state for displaying a button by which the three stages can be defined and which is used in an operation screen image for urging a user to perform operation, display control of the normal state, selected state and activated state of the button by the button images;
deciding, when only one of the button images is associated with the activated state of the button, based on the display control information, whether or not the display of the one button image should be performed for a predetermined period of time within which the activated state of the button can be presented explicitly; and
executing a command, which is executed in response to the activated state of the button, after the display of the button image associated with the activated state of the button comes to an end.

7. A display control program for causing a computer apparatus to execute a display control method, the display control method comprising the steps of:
performing, in response to a user operation for an operation inputting section which accepts a user operation, based on display control information for controlling display of a plurality of button images associated with three states including a normal state, a selected state and an activated state for displaying a button by which the three stages can be defined and which is used in an operation screen image for urging a user to perform operation, display control of the normal state, selected state and activated state of the button by the button images;
deciding, when only one of the button images is associated with the activated state of the button, based on the display control information, whether or not the display of the one button image should be performed for a predetermined period of time within which the activated state of the button can be presented explicitly; and
executing a command, which is executed in response to the activated state of the button, after the display of the button image associated with the activated state of the button comes to an end.
